(19) United States
(12) Patent Application Publication
(10) Pub. No.: US 2023/0394512 A1
(43) Pub. Date: Dec. 7, 2023

(54) METHODS AND SYSTEMS FOR PROFIT OPTIMIZATION

(71) Applicant: JIO PLATFORMS LIMITED, Ahmedabad (IN)

(72) Inventors: Akansha KUMAR, Hyderabad (IN); Shailesh KUMAR, Hyderabad (IN); Akhil PATEL PATLOLLA, Sangareddy (IN); Bangari Sai SWARAJ, Hyderabad (IN); Athira SURENDRAN, Thrissur (IN)

(21) Appl. No.: 18/246,357

(22) PCT Filed: Jun. 25, 2022
(86) PCT No.: PCT/IB2022/055912

§ 371 Date: Mar. 23, 2023

(30) Foreign Application Priority Data
Jun. 26, 2021 (IN) 202121028763

(51) Int. Cl. G06Q 30/0201; G06Q 30/0202; G06Q 30/0204

(52) U.S. Cl. CPC G06Q 30/0206; G06Q 30/0202; G06Q 30/0204

(57) ABSTRACT

The present disclosure generally relates to profit optimization, and more particularly to methods and systems for profit optimization for an online/offline retail/wholesale category. Profit optimization includes demand forecasting, inventory planning, assortment planning, discount recommendation, price optimization, revenue optimization, and profit optimization in the online/offline retail/wholesale category. The method of profit optimization includes a hierarchical demand forecasting of products by using a stacked Long- and Short-Term Memory (LSTM) neural network architecture. Further, the method includes a quantification of price-demand causal effects and inter-product cross-causal effects using an eXtreme Gradient Boosting (XGBoost) technique. The method further includes a simulation of an effect of discount on a demand of products, and recommendation of an optimal discount using a non-linear optimization technique. The method includes performing a product segmentation into clusters by using a K-Nearest neighbour technique. The method further includes determining an optimal price of the products using a real-valued Genetic Algorithm (GA).

### TECHNICAL FIELD

The embodiments of the present disclosure generally relate to profit optimization. More particularly, the present disclosure relates to methods and systems for profit optimization for an online/offline retail/wholesale category, wherein the profit optimization includes demand forecasting, inventory planning, assortment planning, discount recommendation, price optimization, revenue optimization, and profit optimization in retail/wholesale category.

### BACKGROUND OF THE INVENTION

The following description of related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admissions of prior art.

In general, economic and financial modelling and planning may be commonly used to estimate or predict the performance and outcome of real systems, given specific sets of input data of interest. Economic modelling may have many uses and applications. One area in which economic modelling can be applied is an online/offline retail/wholesale environment. Grocery, general merchandise, specialty products, textiles, fashion, and other online/offline retail/wholesale categories may face competition for limited consumers and businesses. Most online/offline retail/wholesale businesses expend great effort to maximize sales, revenue, and profit. On the other side, the consumers may be interested in quality, low prices, comparative product features, convenience, and receiving the most value for the money. Further, there is a lack of access to comprehensive, reliable, and objective product information essential to providing effective comparative shopping services, which restricts the consumer's ability to find the lowest prices, compare product features, and make the best purchasing decisions. Technical challenges may involve a scale of the products, a strong inter-product effect, and a highly sensitive price-demand causal effect.

Conventional methods for discount optimization and recommendation may rely on a use of derivates to find a local optimal solution. However, local derivates are, in general, local in scope and not very robust towards noise. Conventional methods fail to find a global maximum/minimum for these problems. In addition, conventional methods do not enable composite product mapping with discounts to maximize the revenue.

There is therefore a need in the art to provide a method and system that can overcome the shortcomings of the existing prior art.

### Object of the Present Disclosure

Some of the objects of the present disclosure, which at least one embodiment herein satisfy are as listed herein below.

An object of the present disclosure is to provide a method and a system for discount recommendation and profit optimization of products in an online/offline retail/wholesale environment.

An object of the present disclosure is to provide a method and a system for demand forecasting, inventory planning, assortment planning, discount recommendation, price optimization, revenue optimization, and profit optimization.

An object of the present disclosure is to provide a method and a system to facilitate a hierarchical demand forecasting using a Long- and Short-Term Memory (LSTM) neural network architecture.

An object of the present disclosure is to provide a method and a system to facilitate a quantification of price-demand and inter-product/cross causal effects.

An object of the present disclosure is to provide a method and a system to facilitate a simulation of an effect of a discount on a demand for products.

An object of the present disclosure is to provide a method and a system to recommend an optimal discount using non-linear optimization techniques.

An object of the present disclosure is to provide a method and a system to facilitate extracting a sliced structured data from input attributes, transactions, and demand dates using a context builder.

An object of the present disclosure is to provide a method and a system to facilitate product segmentation into competition clusters.

An object of the present disclosure is to provide a method and a system to facilitate searching for the best price using a non-linear optimizer and real-valued genetic techniques.

### SUMMARY

This section is provided to introduce certain objects and aspects of the present invention in a simplified form that are further described below in the detailed description. This summary is not intended to identify the key features or the scope of the claimed subject matter.

In an aspect, the present disclosure provides a system for price optimization. A system for price optimization is disclosed. The system segments one or more products into a complementary product cluster or a competitive product cluster based on a demand history data of the one or more products and attributes of the one or more products. Further, the system performs a demand forecast of the one or more products in the product cluster based on the demand history data of the one or more products and attributes of the one or more products by using a stacked Long- and Short-Term Memory (LSTM) neural network architecture. Further, the system performs a causality analysis of the one or more products in the product cluster based on the demand forecast of the one or more products in the product cluster by using an eXtreme Gradient Boosting (XGBoost) technique. Furthermore, the system sets an optimal price of the one or more products based on the causality analysis of the one or more products by a non-linear price optimization technique by using a real-valued Genetic Algorithm (GA).

In an aspect, the present disclosure provides a method for price optimization. The method includes segmenting, by a processor, one or more products into a complementary product cluster or a competitive product cluster based on a demand history data of the one or more products and attributes of the one or more products. Further, the method includes performing, by the processor, a demand forecast of the one or more products in the product cluster based on the demand history data of the one or more products and attributes of the one or more products by using a stacked Long- and Short-Term Memory (LSTM) neural network architecture. Further, the method includes performing, by the processor, a causality analysis of the one or more products in the product cluster based on the demand forecast of the one or more products in the product cluster by using an eXtreme Gradient Boosting (XGBoost) technique. Furthermore, the method includes setting, by the processor, an optimal price of the one or more products based on the causality analysis of the one or more products by a non-linear price optimization technique by using a real-valued Genetic Algorithm (GA).

### BRIEF DESCRIPTION OF DRAWINGS

The accompanying drawings, which are incorporated herein, and constitute a part of this invention, illustrate exemplary embodiments of the disclosed methods and systems in which like reference numerals refer to the same parts throughout the different drawings. Components in the drawings are not necessarily to scale, emphasis instead being placed upon clearly illustrating the principles of the present invention. Some drawings may indicate the components using block diagrams and may not represent the internal circuitry of each component. It will be appreciated by those skilled in the art that invention of such drawings includes the invention of electrical components, electronic components, or circuitry commonly used to implement such components.

FIG. 1 illustrates an exemplary network architecture (100) in which or with which a proposed system of the present disclosure may be implemented, in accordance with an embodiment of the present disclosure.

FIG. 2 illustrates an exemplary representation (200) of the proposed system for profit optimization, in accordance with an embodiment of the present disclosure.

FIG. 3A illustrates an exemplary block diagram representation (300) of a system architecture, in accordance with an embodiment of the present disclosure.

FIG. 3B illustrates an exemplary block representation (305) of a detailed system architecture, in accordance with an embodiment of the present disclosure.

FIG. 3C illustrates an exemplary flow diagram representation (331) of profit optimization, in accordance with an embodiment of the present disclosure.

FIG. 4 illustrates an exemplary block diagram representation (400) of a composition of data connectors and historical data, in accordance with an embodiment of the present disclosure.

FIG. 5A illustrates an exemplary block diagram representation (500) of a context builder architecture, in accordance with an embodiment of the present disclosure.

FIGS. 5B and 5C illustrate an exemplary block diagram representations (531, 532) of exemplary scenarios in context builder, in accordance with an embodiment of the present disclosure.

FIG. 6 illustrates an exemplary flow chart (600) depicting a product segmentation, in accordance with an embodiment of the present disclosure.

FIG. 7 illustrates exemplary block diagram representation (700) of product segmentation flow, in accordance with an embodiment of the present disclosure.

FIG. 8A illustrates an exemplary block diagram representation (800) of causality flow for quantification of the effects of price variability, in accordance with an embodiment of the present disclosure.

FIGS. 8B and 8C illustrate exemplary flow charts (801, 807) depicting self-causality and cross-causality respectively, in accordance with an embodiment of the present disclosure.

FIGS. 9A and 9B illustrate exemplary flow diagram representations (900, 901) of training a product level self-causal model without competitor weights and with competitor weight, in accordance with an embodiment of the present disclosure.

FIGS. 9C and 9D illustrate exemplary flow diagram representations (909, 911) of Conversion Rate (CR) inference using the trained product level self-causal model without competitor weights and with competitor weights respectively, in accordance with an embodiment of the present disclosure.

FIGS. 9E and 9F illustrate exemplary tabular representations (921, 922) of self-causality weights and cross-causality, respectively, in accordance with an embodiment of the present disclosure.

FIG. 10A illustrates an exemplary flow diagram representation (1000) of hierarchical forecasting flow, in accordance with an embodiment of the present disclosure.

FIG. 10B illustrates an exemplary flow chart (1025) depicting demand forecasting, in accordance with an embodiment of the present disclosure.

FIG. 10C illustrates an exemplary block diagram representation (1041) of forecast flow using a Long- and Short-Term Memory (LSTM) model, in accordance with an embodiment of the present disclosure.

FIG. 10D illustrates an exemplary block diagram representation of a cell state and gates of a cell of the Long- and Short-Term Memory (LSTM) model (1063), in accordance with an embodiment of the present disclosure.

FIG. 10E illustrates an exemplary block diagram representation of a forecast de-aggregator (1064), in accordance with an embodiment of the present disclosure.

FIG. 10F illustrates an exemplary table (1065) of forecast distribution weights, in accordance with an embodiment of the present disclosure.

FIG. 11A illustrates an exemplary flow chart (1100) depicting discount simulation flow (1100), in accordance with an embodiment of the present disclosure.

FIG. 11B illustrates an exemplary flow chart (1111) depicting a discount optimization flow, in accordance with an embodiment of the present disclosure.

FIG. 11C illustrates an exemplary block diagram representation (1125) of an optimization fitness call flow, in accordance with an embodiment of the present disclosure.

FIG. 11D illustrates an exemplary block diagram representation (1126) of a Genetic Algorithm (GA) optimizer flow, in accordance with an embodiment of the present disclosure.

FIG. 11E illustrates an exemplary table (1159) of a sample chromosome/solution, in accordance with an embodiment of the present disclosure.

FIG. 11F illustrates an exemplary table (1160) of illustration of genes in a chromosome (1160), in accordance with an embodiment of the present disclosure.

FIG. 12A illustrates an exemplary table (1200) of N-chromosomes/solution (1200), in accordance with an embodiment of the present disclosure.

FIG. 12B illustrates an exemplary table (1201) of costs based on the fitness of the chromosomes, in accordance with an embodiment of the present disclosure.

FIG. 12C illustrates an exemplary table (1202) of a mutation operator flow, in accordance with an embodiment of the present disclosure.

FIG. 13 illustrates an exemplary computer system (1300) in which or with which embodiments of the present disclosure can be utilized, in accordance with embodiments of the present disclosure.

The foregoing shall be more apparent from the following more detailed description of the invention.

### DETAILED DESCRIPTION OF INVENTION

In the following description, for the purposes of explanation, various specific details are set forth in order to provide a thorough understanding of the embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth.

The present disclosure provides a robust and effective solution to an online/offline retail/wholesale category for a profit optimization. The profit optimization of products in an online/offline retail/wholesale may comprise recommending an optimal price and a discount for the product and providing a simulation environment for analyzing an effect of the discount on the demand for the products in the online/offline retail/wholesale environment. Further, the present disclosure enables scaling of the products and provides a strong inter-product effect and a highly sensitive price-demand causal effect. Some aspects of the disclosure provide a Machine Learning (ML) and/or Artificial intelligence (AI) model to solve the problem at scale and speed. The present disclosure proposes a product segmentation module, a demand forecasting module, a causality module, and a non-linear optimizer module. In an embodiment, a demand forecasting may be performed using a stacked Long- and Short-Term Memory (LSTM) neural network architecture. Disclosed embodiments propose non-linear optimization that may be performed using a real-valued Genetic Algorithms (GA).

Furthermore, disclosed embodiments propose causal models that may use an eXtreme Gradient Boosting (XGBoost) technique to quantify the inter-product effects. At every stage of modelling of the disclosed embodiments, local features such as calendar events and demographic parameters may be used, which help in a quantification of price-demand causal effects and inter-product cross-causal effects.

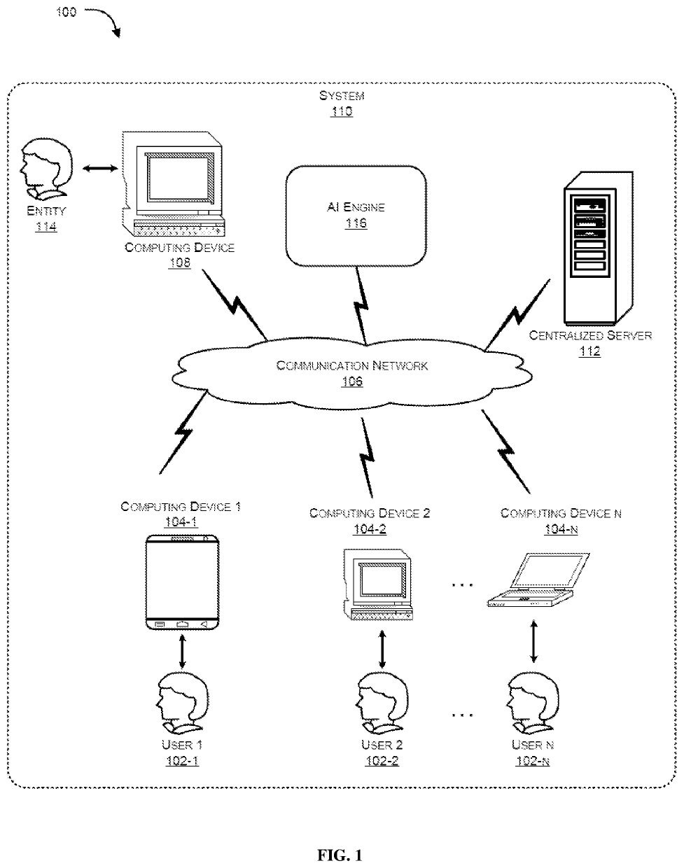

Referring to FIG. 1 which illustrates an exemplary network architecture (100) for a profit optimization system (110), in accordance with an embodiment of the present disclosure. As illustrated, the exemplary architecture (100) may implement an Artificial Intelligence (AI) engine (116) for facilitating a price optimization and a discount recommendation to users (102-1, 102-2, 102-3 . . . 102-N) (individually referred to as the user (102) or the employer (102) and collectively referred to as the users (102) or the employers (102)) associated with one or more first computing devices (104-1, 104-2 . . . 104-N).

The system (110) may be further operatively coupled to a second computing device (108) associated with an entity (114). In an embodiment, the entity (114) may include a company, a university, a lab facility, a business enterprise, a defence facility, or any other secured facility. The system (110) may be communicatively coupled to the one or more first computing devices (individually referred to as the first computing device (104) and collectively referred to as the first computing devices (104).

The system (110) may be coupled to a centralized server (112). The centralized server (112) may also be operatively coupled to the one or more first computing devices (104) and the second computing devices (108) through a communication network (106).

In an embodiment, system (110) may forecast a hierarchical demand using a Long- and short-Term Memory (LSTM) technique. In an embodiment, forecasting may include forecasting the demand for products for a future date using the LSTM technique. Forecasting may be performed on complementary product clusters and then disaggregated to a product level. In an embodiment, the system (110) may also quantify price-demand causal effects using the eXtreme Gradient Boosting (XGBoost) technique based on historical behavior, calendar effects, and demographic effects. A causal model may predict the conversion rate i.e., demand converting to an actual sale.

In another embodiment, the system (110) may simulate an effect of discount on a demand for products and competing products

In yet another embodiment, the system (110) may recommend an optimal discount using a one or more non-linear optimization techniques. In an embodiment, the one or more non-linear optimization techniques may be applied for the profit optimization of non-identical products.

In an embodiment, the system (110) may present a slicing/filtering system such as a context-builder, which helps in extracting sliced structured data from input attributes, transactions, and demand dates, based on a user-inputted query fed as a JSON file.

In another embodiment, the system (110) may perform a product segmentation into competition clusters using hybrid rules and unsupervised methods using a K-Nearest neighbor method.

In yet another embodiment, the system (110) may search for the best price using the real-valued Genetic Algorithms (GA) via a non-linear optimizer.

In an embodiment, the system (110) may include, but not limited to, a profit optimization system, a demand management system, a demand forecasting system, a discount recommendation system, a price optimization system, an inventory planning system, a revenue optimization, and a profit optimization system, and the like. Further, the AI engine (116) of the system (110) may include, but not limited to, a product segmentation module, a demand forecasting module, a causality module, a non-linear optimizer module, and the like. A set of instructions and a database may be deployed and run on production-grade cloud environments, but not limited to it. In an exemplary embodiment, the system (110), may function independently to optimize profit in an online/offline retail/wholesale environment. In yet another embodiment, historical data synchronization, remote updating, and synchronization may take place with a cloud-based application and database.

In an embodiment, the network architecture (100) may be modular and flexible to accommodate any kind of change in the system (110) as proximate processing may be acquired towards profit optimization in the online/offline retail/wholesale category. In an embodiment, the system (110) configuration details may be modified on the fly.

In an embodiment, the system (110) may be remotely monitored, and the data, application, and physical security of the system (110) may be fully ensured. In an embodiment, the data may get collected meticulously and deposited in a cloud-based data lake to be processed to extract actionable insights. Therefore, the aspect of predictive maintenance may be accomplished.

In an exemplary embodiment, a communication network (106) may include, by way of example but not limitation, at least a portion of one or more networks having one or more nodes that transmit, receive, forward, generate, buffer, store, route, switch, process, or a combination thereof, etc. one or more messages, packets, signals, waves, voltage or current levels, some combination thereof, or so forth. A network may comprise by way of example but not limitation, one or more of: a wireless network, a wired network, an internet, an intranet, a public network, a private network, a packet-switched network, a circuit-switched network, an ad hoc network, an infrastructure network, a Public-Switched Telephone Network (PSTN), a cable network, a cellular network, a satellite network, a fiber optic network, some combination thereof.

In another exemplary embodiment, the centralized server (112) may include or comprise, by way of example but not limitation, one or more of a stand-alone server, a server blade, a server rack, a bank of servers, a server farm, hardware supporting a part of a cloud service or system, a home server, hardware running a virtualized server, one or more processors executing code to function as a server, one or more machines performing server-side functionality as described herein, at least a portion of any of the above, some combination thereof.

In an embodiment, the one or more first computing devices (104), and the one or more second computing devices (108) may communicate with the system (110) via a set of executable instructions residing on any operating system, including but not limited to, Android™, iOS™, Kai OS™ and the like. In an embodiment, the one or more first computing devices (104), and the one or more second computing devices (108) may include, but not limited to, any electrical, electronic, electro-mechanical or an equipment or a combination of one or more of the above devices such as mobile phone, smartphone, Virtual Reality (VR) devices, Augmented Reality (AR) devices, laptop, a general-purpose computer, desktop, personal digital assistant, tablet computer, mainframe computer, or any other computing device, wherein the computing device may include one or more in-built or externally coupled accessories including, but not limited to, a visual aid device such as camera, audio aid, a microphone, a keyboard, input devices for receiving input from a user such as a touchpad, a touch-enabled screen, an electronic pen, receiving devices for receiving any audio or visual signal in any range of frequencies and transmitting devices that can transmit any audio or visual signal in any range of frequencies. It may be appreciated that the one or more first computing devices (104), and the one or more second computing devices (108) may not be restricted to the mentioned devices and various other devices may be used. A smart computing device may be one of the appropriate systems for storing data and other private/sensitive information.

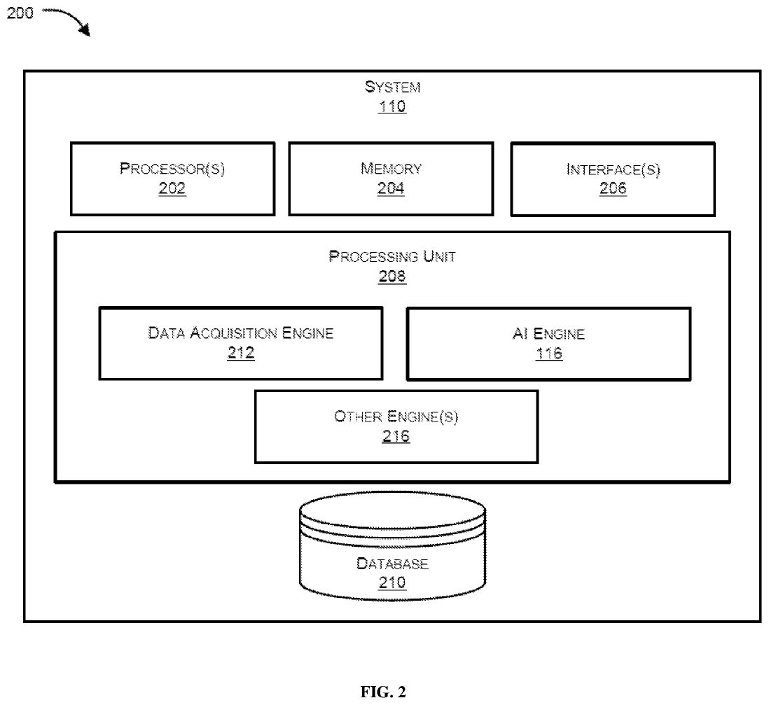

FIG. 2, with reference to FIG. 1, illustrates an exemplary representation (200) of the system (110) for facilitating profit optimization, in accordance with an embodiment of the present disclosure. In an aspect, the system (110) may comprise one or more processor(s) (202). The one or more processor(s) (202) may be implemented as one or more microprocessors, microcomputers, microcontrollers, edge or fog microcontrollers, digital signal processors, central processing units, logic circuitries, and/or any devices that process data based on operational instructions. Among other capabilities, the one or more processor(s) (202) may be configured to fetch and execute computer-readable instructions stored in a memory (204) of the system (110). The memory (204) may be configured to store one or more computer-readable instructions or routines in a non-transitory computer readable storage medium, which may be fetched and executed to create or share data packets over a network service. The memory (204) may comprise any non-transitory storage device including, for example, volatile memory such as RAM, or non-volatile memory such as EPROM, flash memory, and the like.

In an embodiment, the system (110) may include an interface(s) 206. The interface(s) (206) may comprise a variety of interfaces, for example, interfaces for data input and output devices, referred to as I/O devices, storage devices, and the like. The interface(s) (206) may facilitate communication of the system (110). The interface(s) (206) may also provide a communication pathway for one or more components of the system (110) or the centralized server (112). Examples of such components include, but are not limited to, processing unit/engine(s) (208) and a database (210). In an embodiment, the database (210) may be of a Parquet (422) file format and an Optimized Row Columnar (ORC) file format (424) as described in FIG. 4 (400).

The processing unit (208) may be implemented as a combination of hardware and programming (for example, programmable instructions) to implement one or more functionalities of the processing engine(s) (212, 116, 216). In examples described herein, such combinations of hardware and programming may be implemented in several different ways. For example, the programming for the processing unit (208) may be processor executable instructions stored on a non-transitory machine-readable storage medium and the hardware for the processing unit (208) may comprise a processing resource (for example, one or more processors), to execute such instructions. In the present examples, the machine-readable storage medium may store instructions that, when executed by the processing resource, implement the processing unit (208). In such examples, the system (110) may comprise the machine-readable storage medium storing the instructions and the processing resource to execute the instructions, or the machine-readable storage medium may be separate but accessible to the system (110) and the processing resource. In other examples, the processing engine(s) (208) may be implemented by electronic circuitry.

The processing unit (208) may include one or more engines selected from any of a data acquisition engine (212), an AI engine (116), and other engines (216). The processing unit (208) may further enable edge-based microservice event processing but not limited to the like. The data acquisition engine (212) of the processing unit (208) may read a historical data of a product and then transform the historical data of the product for improving quality. Further, the data acquisition engine (212) may conduct a feature engineering to analyze one or more features of the product and then may segment the product into clusters on the basis of the attributes of the product. Furthermore, the data acquisition engine (212) may forecast a demand for the product and correct a causality and forecast of the demand for the product before transmitting the data to the AI engine (116) of the processing unit (208). like. The data acquisition engine (212) of the processing unit (208) may be programmed with a language Application Program Interface (API) (404) such as python (416), a hive Query Language (QL) (418), a spark Structured Query Language (SQL) and a spark Resilient Distributed Datasets (RDD) data frame (420) as described in FIG. 4 (400).

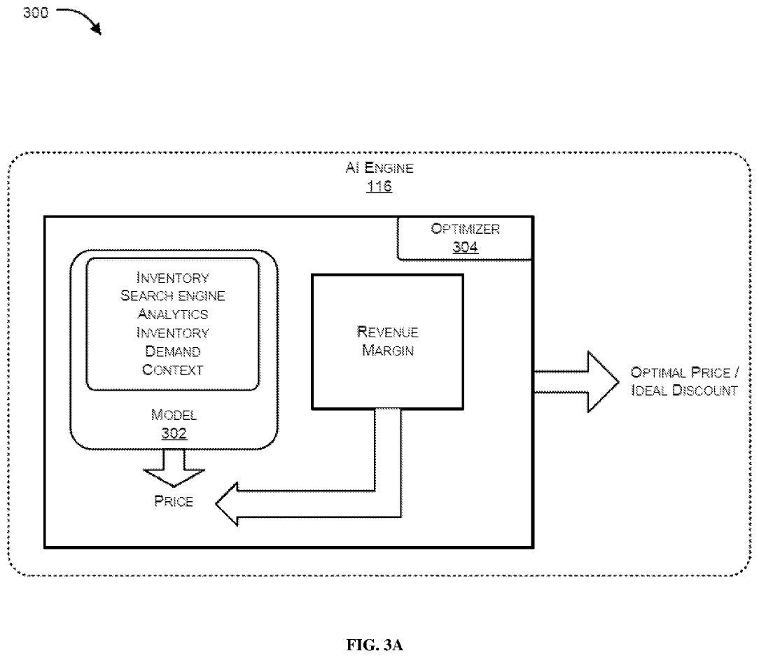

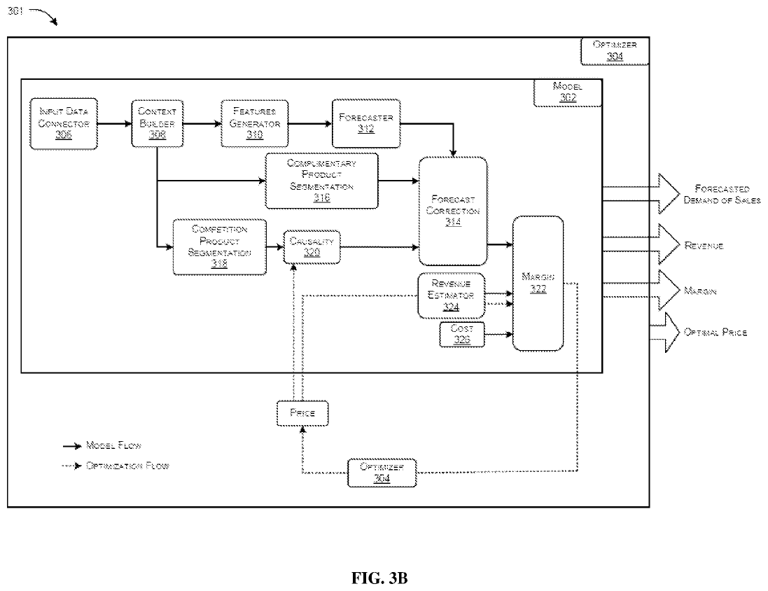

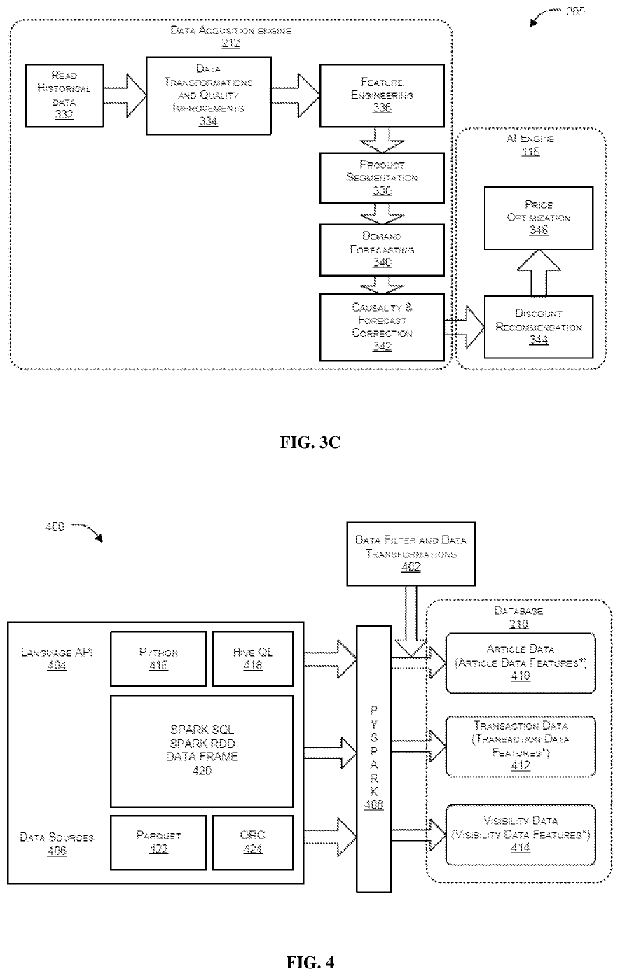

FIG. 3A illustrates an exemplary block diagram representation (300) of a system architecture of the AI Engine (116), in accordance with an embodiment of the present disclosure.

As illustrated, in an embodiment, the system architecture includes modules/units, but not limited to, a model (302), an optimizer module (304), and the like. The model (302) may be a central decision system, and the optimizer module (304) may perform an exhaustive search in a price space and may recommend an appropriate set of discounts for each product.

In an embodiment, the input to the model (302) may be a price detail of products and the output of the model (302) may be a revenue and a gross margin price of the products. In a simplified form the model (302) enables a function according to equation 1 below:

[revenue, margin]=f (P) Equation 1

According to equation 1, for a price vector that corresponds to the price of all the products, the model (302) returns the revenue and the gross margin. A functional form for “f” in the above equation 1, is not known as ‘f’ includes several levels of cascaded learning models which may be non-linear learning models.

In an embodiment, the model (302) may perform functions that may include, but not limited to, a demand forecasting, a self-causality, a cross causality, and the like. In an embodiment, the function of demand forecasting may be to forecast the demand of the products for a future date. The model (302) may learn from, but not limited to, a historical transaction data, a product attributes data, a calendar events data, a demographic data and the like, to build a neural network. The neural network may be used to forecast future dates. In an embodiment, the function of self-causality includes understanding and quantifying effects of price on the demand for the complementary products. For instance, self-causal effects may affect the demand for the product when the price of the product is changed. For instance, if the price of the product increases, the demand decreases and vice versa. In an embodiment, the function of a cross-causality includes analyzing, and quantifying the effects of price on the demand for competing products. For instance, in the online/offline retail/wholesale category, if the customers have good availability of products to choose from, then there is a strong competition effect across products that are similar to each other. The similar products may be first clustered into competition clusters and then a causality analysis may be performed in the competition clusters with an assumption that there is a significant causal effect across products in a cluster and the effect across clusters may be negligible.

FIG. 3B illustrates an exemplary block representation (305) of the AI Engine (116), in accordance with an embodiment of the present disclosure.

In an embodiment, the model (302) may include an input data connector module (306), a context builder module (308), a features generator module (310), a forecaster module (312), a forecast correction module (314), a complementary product segmentation module (316), a competition product segmentation module (318), a causality module (320), a margin module (322), a revenue estimator module (324), and a cost module (326).

In an embodiment, the input data connector module (306) may include data connectors such as the language Application Program Interface (API) and data sources (406) that may provide a real-time data feed during business use and inference stages. The context builder module (308) may be a custom filtering and slicing module that accepts an attributes data and a transactions data as an input data and returns a structured data that is filtered and sliced from the input data. The features generator module (310) takes an attributes data and a transaction data as an input data for data processing. Further, the features generator (310) and the context builder (308) may output a historic contribution of SKUs and a historic contribution of products to a product cluster.

In an embodiment, the forecaster module (312) may provide SKU level forecast of demand for products. The forecast correction module (314) may estimate a correction in the demand for the products based on a quantification of a relationship between the price of the product and the demand for the product. The complementary product segmentation module (316) may create complementary clusters of products and the competition product segmentation module (318) may create competitive clusters of products based on the attributes of the products. The causality module (320) may analyze and quantify an effect of the price of the product on the demand for products. The margin module may estimate a gross margin of the product and the revenue estimator module may estimate a revenue associated with the products. The cost module (326) may estimate a cost of the product.

In an embodiment, the model (302) may output, but not limited to, a forecasted demand of the sales at the optimal price, the optimal price, an expected revenue, and the gross margin as depicted in FIG. 3B. In an embodiment, the parameters from the output of the model (302) may be presented for a plurality of Stock Keeping Units (SKUs).

In an embodiment, the output of the model (302) such as a sales forecast may include an expected sale of the products. For a SKUi, the forecasted demand of sales may be given as Qᵢ.

In an embodiment, the output of the model (302) such as the revenue may be calculated using equation 2:

R=Σᵢ₌₁^{I}(1−Dᵢ)*Pᵢ*Qᵢ Equation 2

In equation 2, the term “Pᵢ” refers to a Maximum Retail Price (MRP) of the product ‘i’ and at discount “Dᵢ”.

In an embodiment, the output of the model (302) such as margin may include the gross margin that may be calculated using equation 3:

GRM=Σᵢ₌₁^{I}{[(1−Dᵢ)*Pᵢ]−Cᵢ}/[(1−Dᵢ)*Pᵢ] Equation 3

In equation 3, the term “Cᵢ refers to cost of product ‘i’.

In an embodiment, the output of the model (302) such as the optimal price may be calculated using equation 4:

(1−Dᵢ)*Pᵢ Equation 4

In equation 4, the term Dᵢ and Pᵢ refers to a Maximum Retail Price (MRP) of the product ‘i’ and at the discount “Dᵢ”.

FIG. 3C illustrates an exemplary flow diagram (331) representation of profit optimization, in accordance with an embodiment of the present disclosure.

In an embodiment, the system (110) may perform method steps such as in step (332) reading a historical data of a product, in step (334) transforming the historical data of the product for improving quality, in step (336) conducting feature engineering to analyze one or more features of the product, in step (338) segmenting the product, in step (340) forecasting the demand for the product, in step (342) correcting causality and forecast, in step (344) recommending a discount, at step (346) optimizing a price of the product.

In step (332), reading a historical data of a product may include, but not limited to, data ingestion, data mapping, data pipelining, and the like. In a data ingestion step, the historical data of the product may get stored in the database (210) for analysis required for the discount recommendation of the product. In data mapping step, the historical data of the product, stored in the database (210), may be analyzed based on the attributes of the products that may help with segmenting products into clusters. In data pipelining, the historical data may get fetched from the database (210) that may provide real-time data feed during business use and inference stages.

In step (334), transforming the historical data of the product for improving quality may include, but not limited to, filling a missing data, data synchronization, data labelling, and the like. In this step (334), the missing historical data of the products may be stored in the database (210) for handling data sparsity in order to ensure that there are no unknown historical data points of the products in the database (210). In this step (334), the historical data of the products is consolidated in order to maintain a data synchronization between the historical data of the products and an existing data of the products in the database (210). Further, after data synchronization, the historical data of the products may be tagged on the basis of the attributes of the product for data labelling in the database (210).

In step (336), performing feature engineering to analyze one or more features of the product may include, but not limited to, a feature generation, a dimensionality reduction, and the like. In the feature generation, the features of the product may be analyzed to create more features that may be used in forecasting the demand for the product on the basis of the existing features of the product and the generated features of the product. In step (336), dimensionality reduction may be performed on the features of the product during feature engineering to eliminate correlated features of the product and redundant features of the product and obtain a set of features that may later be used for forecasting the demand for the product for discount recommendation and profit optimization.

In step (338), segmenting the product may include, but not limited to, an attribute-based product grouping, an unsupervised-based clustering, and the like. In this step (338), the product may be segmented into clusters on the basis of the attributes of the product. There may be an attribute-based product grouping in which the products may be grouped into clusters based on an individual attribute of the product during product segmentation. In the unsupervised-based clustering, the products may be grouped into clusters on the basis of similar attributes.

At step (340), forecasting a demand for the product may include, but not limited to, LSTM-based demand sensing, LSTM-based forecast predictions, and the like. In step (340), forecasting the demand for the product may involve LSTM-based demand sensing. In LSTM-based demand sensing, a short-term demand for the product may be considered by detecting a sudden or sporadic change in the demand for the product for discount recommendation and profit optimization of the product. In LSTM-based forecasting of predictions, both long-term and short-term demand for the product may be considered for discount recommendation and profit optimization of the product.

In step (342), correcting causality and forecast may include, but not limited to, inter-product effect and causality analysis, quantification of competition and a one or more cannibalization effects, and the like. In step (342), inter-product effect and causality analysis may be performed on competition clusters of the products for discount recommendation and profit optimization of the product. The one or more cannibalization effects may also be considered at the causality and forecast correction step (342) to estimate a reduction in the revenue of the products in the cluster when a new product may get added to the cluster. The reduction in the revenue due to an addition of the new product may be taken into consideration for discount recommendation and profit optimization of the product.

In step (344) recommending a discount may include, but not limited to, searching several price points/discounts for the product, calculating the revenue and the gross margin, and the like. In step (346) optimizing may include, but not limited to, the non-linear optimization of the price of the product to select the best discount/price, and the like. In step (346), non-linear optimization of the price of the product may be performed.

FIG. 4 illustrates an exemplary block diagram representation (400) of a composition of data connectors and historical data, in accordance with an embodiment of the present disclosure.

In an embodiment, to fetch a historical transaction data of the product from the database (210), the system (110) may use a language Application Program Interface (API) (404) such as the Python (416), the hive Query Language (QL) (418), the spark Structured Query Language (SQL) and the spark Resilient Distributed Datasets (RDD) data frame (420). Further, to fetch a demand and attributes data from the database (210), the system (110) may use data sources (406) of Parquet (422) file format and Optimized Row Columnar (ORC) file format (424).

The language Application Program Interface (API) (404) and the data sources (406) may fetch the historical transaction data and a demand and attributes data from the database (210) to input to the Python Spark (PySpark) (408). At the data filtering and data transformation stage (402), the PySpark (408) may output an article data (410), a transaction data (412), and a visibility data (414) that may be stored in the database (210). In an embodiment, the data connectors such as the language Application Program Interface (API) (404) and the data sources (406) may provide a real-time data feed during business use and inference stages.

In an embodiment, the article data (410) may include, but not limited to, specific attributes of the product such as an article number i.e., a unique ID for the product, a product code that may be specific to the article number followed by a variant information, a price of the product, a one or more commercial attributes such as a launch platform, a segment, portfolio, a brand, and a launch date. Further, the article data (410) may include, but not limited to, a style attribute such as size, color, fit, length, neckline, fabric, sleeve styling, and pattern. The article data (410) may help to build a competitor relationship between the products and may find out the products which may express a same attribute behavior. For instance, the article data (410) may be a number of SKUs active in the last 3 months for “Men's T-Shirt” category which are—97000. In some instances, all the categories, active SKUs—2.5 million may be considered. The products may have several attributes such as size, color, fit, neckline, and the like.

In an embodiment, the transaction data (412) may express a behavior of sales of the product. Statistical information of a price attribute may include, but not limited to, a Maximum Retail Price (MRP) listed, and promotions such as a trade discount which is offered by a business and a voucher discount which is offered to a specific customer/group on any product, a Goods and Service Tax (GST) recovery for a product, a revenue generated for a sale of the product, a shipping charge for a given time, and the like. A quantitative information may include, but not limited to, a gross quantity, a net quantity, an ordered quantity, a returned quantity, and the like. Further, the platform attribute may include an information platform used for the transaction. Further, a hashed customer ID information and a demographic information like a ZIP CODE may also be listed. For instance, an availability of sales quantity, an MRP and a sale price of the products for the past three years. The transaction data (412) may be noisy in terms of irregularity in sales and frequent promotions and campaigns.

In an embodiment, the visibility data (414) may provide an e-commerce information such as, but not limited to, views and clicks of the product a listed page information, and a product description information. For instance, PDP_VIEWS contains the views of the product description information whereas PLP_VIEWS and PLP_CLICKS express product listing page views and clicks respectively. Further, the visibility data (414) may also include an information of conversion such as “add to cart” or “check out” which expresses a high probability of a purchase. For instance, a Product Display Page (PDP) View may be a page view of a display page of the product. The availability of two years of historical data may be considered.

In an example, the challenges may be for scale, daily forecasting for one lakh products, and daily discount recommendations for the one lakh products. Further, for an inter-product effect, if products A and B are part of a competition cluster, a discount is provided to Product A as part of a promotion, the Product A gets a lift in its sales due to the discount. This inter-product effect is called a gain in competition due to a promotion which leads to a loss in Product B sales. This inter-product effect is called a loss to competition due to a promotion. Quantifying an inter-product cross effect at scale, speed and accuracy is a challenge.

There may be causality, in which modelling the inter-product cross effect may quantify the effect of price on the demand for the product and its competing products. A digital twin may be used for a single pass-through function that estimates the business KPIs such as a total revenue, and a total gross margin price based on an estimated forecast for a demand at a specific price point. This is a simulation/emulation of a sales system. Further, an optimization may be a wrapper that searches for the best price point for the product to maximize the revenue and meet the gross margin norms.

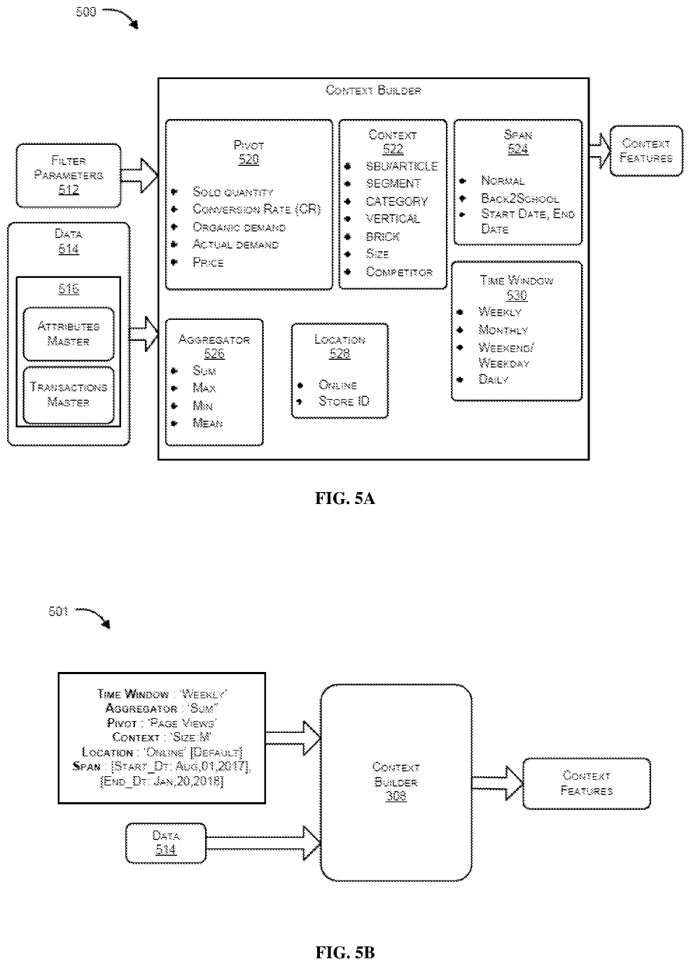

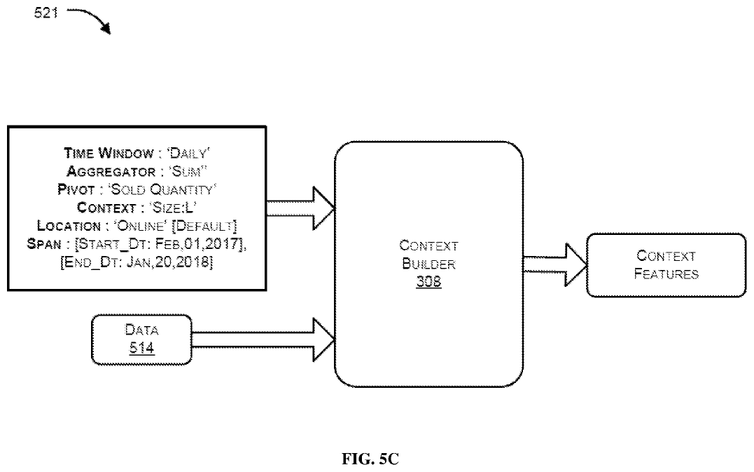

FIG. 5A illustrates an exemplary block diagram representation (500) of a context builder architecture, in accordance with an embodiment of the present disclosure.

The context builder (308) may be a custom filtering and slicing module that may receive an attributes data and a transactions data (516) as an input data (514). Based on a user-defined query (provided as a JSON input) such as a one or more filter parameters (512), the context builder (308) may return a structured data output that is filtered and sliced from the input data (514). The context builder (308) may include several components such as a pivot (520), a context (522), a span (524), an aggregator (526), a location (528), and a time window (530). The pivot (520) may correspond to a parameter that is being measured. The pivot (520) may usually be a time series data. For instance, the pivot (520) may include a sale of the product, a price of the product, a demand for the product, and the like. Further, the context (522) may correspond to a filter level based on the attributes of the product. For instance, in a/an online/offline retail/wholesale fashion category, the context may be a size of the product, a color of the product, and the like. Furthermore, a span parameter may correspond to a time range to be filtered to slice the input data (514). Filtering may also be a date range or else pre-defined categories such as Back2School, and so on.

FIG. 5B and 5C illustrate an exemplary block diagram representation of exemplary scenarios (531 and 532 respectively) in the context builder (308), in accordance with an embodiment of the present disclosure.

In an example, as depicted in FIG. 5B, a weekly aggregated page views of products of size Medium (M), which may be sold online/offline between the dates 1 Aug. 2017 and 20 Aug. 2018, may be fed as the input data (514) to the context builder (308). The output context features from the context builder (308) may be as shown in Table 1, below:

TABLE 1

| Article | Week | Page Views |
|---|---|---|
| A1 | W29-2017 | 380 |
| A1 | W30-2017 | 240 |
| — | | |
| A1 | W3-2018 | 460 |
| A2 | W29-2017 | 160 |
| . . . | | |

In another scenario, consider exemplary scenario of FIG. 5C. A daily sold quantity of products of size Large (L), which may be sold online/offline between dates 1 Feb. 2017 and 20 Aug. 2018, may be fed as the input data (514) to the context builder (308). The output context features from the context builder (308) may be as shown in Table 2, below:

TABLE 2

| | | Sold |
|---|---|---|
| Article | Day | Quantity |
| A1 | 1 Feb. 2017 | 12 |
| A1 | 1 Feb. 2017 | 11 |
| — | | |
| A1 | 2 Aug. 2017 | 14 |
| A1 | 2 Feb. 2017 | 10 |
| . . . | | |

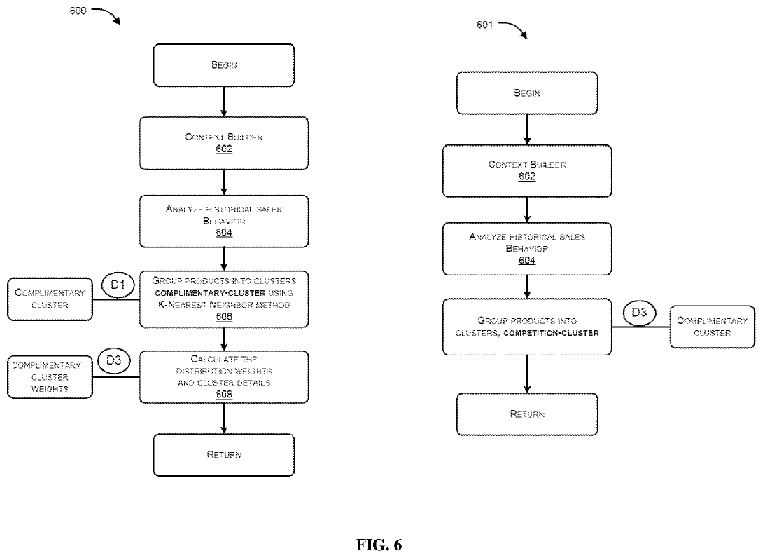

FIG. 6 illustrates an exemplary flow chart (600) depicting a product segmentation, in accordance with an embodiment of the present disclosure.

In an embodiment, the system (110) may be implemented as a series of process/data flows that may be executed wither in parallel or in series. A process/data flow may serve a specific purpose. In an instance, the complementary product segmentation (316) may include, in step (602), building a context by the context builder 308.

Instep (604), a historical sales behaviour may be analyzed. In this step (604), historical sales behavior data may be obtained from the database (210) and may be analyzed for assessing the sale of the products over a particular period of time. In step (606), the products may be grouped into clusters such as complementary clusters using K-nearest neighbour method. In step (608) distribution weights and cluster details may be calculated by the KNN method to recommend the best set of discounts for each product. In an instance, the competition product segmentation (318) may include, in step (602), building the context, in step (604), analyzing the historical sales behavior, and in step (610), grouping products into clusters such as competition clusters.

In an instance, a promotion on a product may affect the sales of a similar product (that is of the same price range, size, neckline, fit etc.) within the brand or a different brand. Even when the sales of a promoted product increase, it may affect the sales of competing products. Hence, it may be important to analyze a promotion effect of a product with respect to the competing products. To analyze a cross-price elasticity effect of the products, first we have to cluster the products based on competition. Two levels of clustering may be considered. At a first level, a similarity-based clustering may be performed, based on the product attributes. MRP bins, size, colour, fit, neckline may be considered for the same. In an instance, the user (102) may decide to buy a cloth item within a range of 100-1500 Indian Rupees. The user (102) may not be considering the item within the range of 2500-3000 Indian rupees. The same example may apply to the other attributes assuming that the competing products may only arise in the same MRP bin, size, fit, and neckline category. To find top competing products within this category, a historic sales data with a promotion information may be considered. Further, a sale of two products may have a negative correlation, which implies that the sales of one brand may be affecting the other brand.

In this way, top ‘n’ competitors may be found. A K-Nearest Neighbour (KNN) clustering technique may be a similarity-based non-parametric method which may belong to the class of supervised machine learning algorithms. Further, the KNN clustering technique may be used for a classification problem as well as a regression problem. In the classification problem, a new data point may be assigned to one of a pre-defined label/class based on a majority of labels from a plurality of k-neighbour data points. The plurality of k-neighbour data points may be determined based on, but not limited to, a distance metric, a Euclidean measure, and the like. For the regression problem, an average of the plurality of k-neighbour data points may be considered. However, the KNN clustering technique may be only approximating the function locally. There may be no training phase for the KNN clustering technique, hence it may be a lazy learner. Since there is no training phase, a prediction may be relatively expensive. Every time to make the prediction, the KNN clustering technique may have to go through an entire dataset. Since the KNN clustering technique is not dependent on any model to make the prediction, it may be easy to interpret a result.

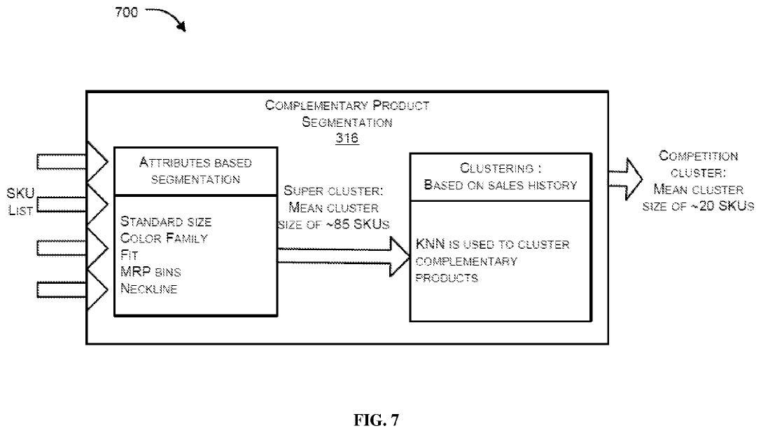

FIG. 7 illustrates an exemplary block diagram representations (700) of product segmentation flow, in accordance with an embodiment of the present disclosure.

In an embodiment, the SKU list may be provided to the complementary product segmentation module (316) as input, as shown in FIG. 7. An attribute-based segmentation of the products may take place in the complementary product segmentation module (316) or the competition product segmentation module (318). In an embodiment, the attributes of the products that may be considered for segmenting the products into complementary clusters may comprise standard size, color family, fit, MRP bins, and neckline. A super cluster with a mean cluster size of 85 SKUs may be formed based on the sales history of the products. A sales correlation may be estimated by considering top twenty negatively correlated products in the complementary product segmentation module (316) or the competition product segmentation module (318). An output of the complementary product segmentation module (316) or the competition product segmentation module (318) may be a competition cluster with a mean cluster size of 20 SKUs.

In an embodiment, a product grouping may be an identification of similar products to form a competition cluster, which may be, for instance, a two-step process. In an embodiment, step-1 may involve using a product attribute and a business imperative in a “super-cluster”. An example of the business imperative may be, for instance, the user (102) searching for a product (e.g., shirt) of size ‘L’ may not choose a size ‘M’ product even though size ‘M’ product may be available at a significantly discounted price. Hence, a size may be the attribute considered for the competition cluster. In an embodiment, step-2 may involve a use of the historical transaction data to split the “super clusters” into clusters. This step involves functions such as assuming to find competition products for SKU1, finding instances when SKU1 sales may be changed (e.g., 0: No change, +1: positive change, −1: negative change, Stride 1: vector [+1, −1,0,−1,+1,−1,−1, . . . ][slope . . . ]). In instances of the direction change may be SKU2 (e.g., 0: No change, −1: positive change, +1: negative change, Stride 1: Vector [−1,+1,0,−1,−1,1,1, . . . ] [slope . . . ])

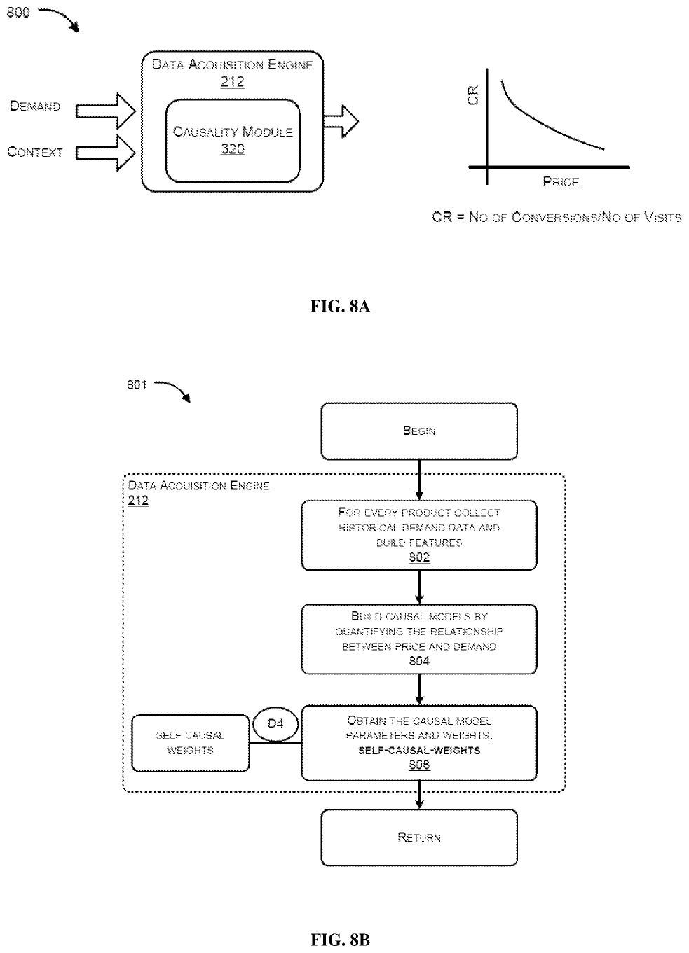

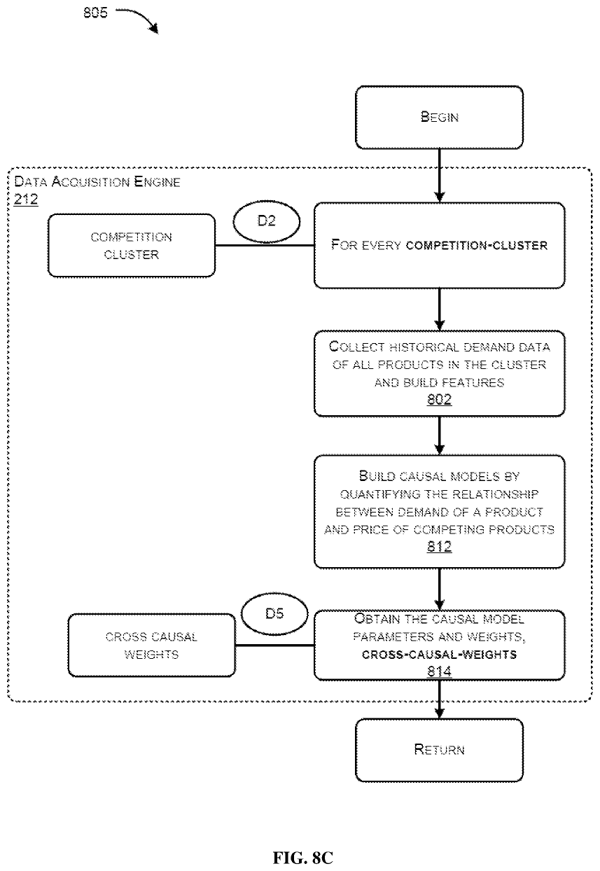

FIG. 8A illustrates an exemplary block diagram representation (800) of causality (320) flow for a quantification of an effect of a price variability of the products, in accordance with an embodiment of the present disclosure.

In an embodiment, the quantification of the effect on the products of the price variability of the products may be determined by the causality module (320). The price variability may be a cause which affects the demand for a product. A causal learning-based model may be built to quantify the effects of the price variability on a Conversion Rate (CR), which may be as per equation 5:

estimate the function ƒ_{P→CR} Equation 5

such that,

Conversion Rate (CR)=ƒ_{P→CR}(P) Equation 6

In the above equation 6, “P” refers to the price, and

$$“ C R ” = \frac{D}{P D P} ,$$

where “D” may refer to an actual sold quantity/demand.

Using a time series forecasting model, PDP views for the product may be forecasted and annotated as [symbol] . Hence, a forecasted demand at a price (pₖ) may be given as in equation 7:

\hat{D}= [symbol] *CR Equation 7

### Substituting for CR,

\hat{D}= [symbol] *ƒ_{P→CR}(pₖ) Equation 8

Similarly, a forecasted revenue at the price (pₖ) may be given as in equation 9:

\hat{R}=pₖ* [symbol] *ƒ_{P→CR}(pₖ) Equation 9

FIGS. 8B and 8C illustrate exemplary flow charts depicting self-causality (801) and cross-causality (807), respectively, in accordance with an embodiment of the present disclosure.

Referring to FIG. 8B, a self-causality is used to quantify the effect of the price variability on itself. A change in the price due to a discount may be a cause. The Conversion Rate (CR) of the product may be an effect. An updated quantity (actual demand) may be according to equation 8 (i.e., \hat{D}= [symbol] *ƒ_{P→CR}(pₖ)). During training, a model may be built based on a historic price and environmental features, according to equation 10 below:

CR=ƒ_{P→CR}(P)=ƒ_{(Price,Date)} Equation 10

In an exemplary instance, for a given date, the CR may be predicted using the trained model for the particular date and the test price. i.e., Infer CR=ƒ_{P→CR}(P)=ƒ_{(Price,Date)} (i.e., equation 10), wherein the PDP may be forecasted using a forecast model to get updated quantity “ [symbol] and updated revenue “\hat{R}”.

To find out the effect of the price variability on the demand, the causal parameter i.e., the Conversion Rate (CR) may be considered a function of the price and the environmental features. Hence, “X” may be a discount for a product offered as a price feature, and different levels of date features such as day, month, year, week representations, and quarter representations, and a target value “Y” may be the Conversion Rate (CR). Thereafter, estimating the function ƒ_{P→CR} such that, CR=ƒ_{P→CR}(P), where “P” may be the price and, the conversion rate

$$( C R ) = \frac{D}{P D P} ,$$

where “D” may be the actual sold quantity/demand.

Since, data sparsity specific to the product may be high, an eXtreme Gradient Boosting (XGBoost) model may be used to handle the missing data. The eXtreme Gradient Boosting (XGBoost) model makes it convenient for parallelization when a product level modelling is handled. The XGBoost model may handle non-linear relationships and make a continuous training on an existing XGBoost model with daily added data in the future. A cost function for an XGBoost regress or may be provided based on equation 11:

$${\sum }_{i = 1}^{n} L ( {y}_{i} , {p}_{i} ) + \frac{1}{2} λ {O}_{v}^{2} \qquad Equation 11$$

In the equation 11, “Oᵥ” refers to an output value.

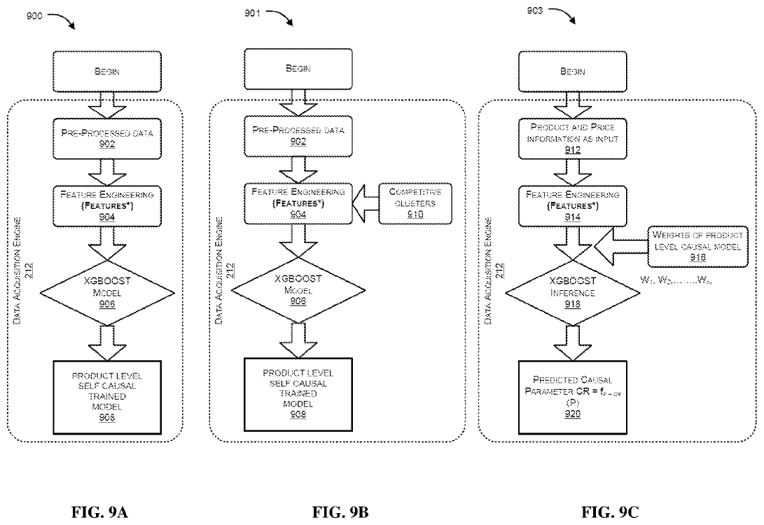

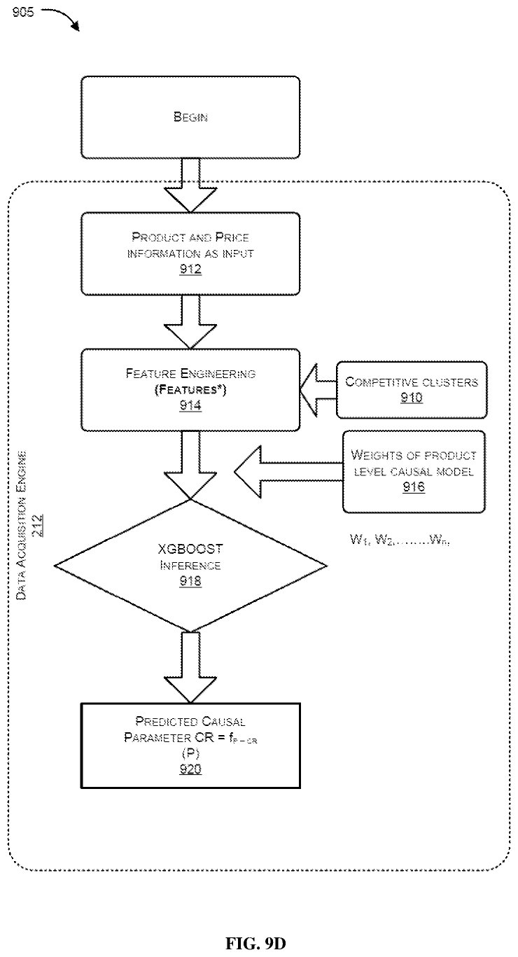

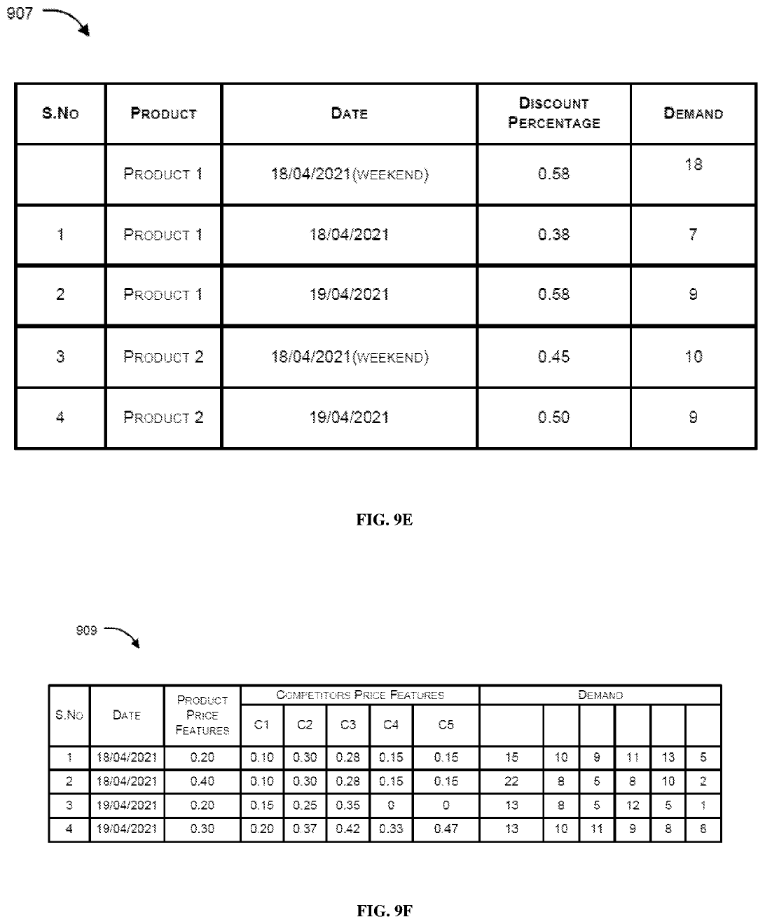

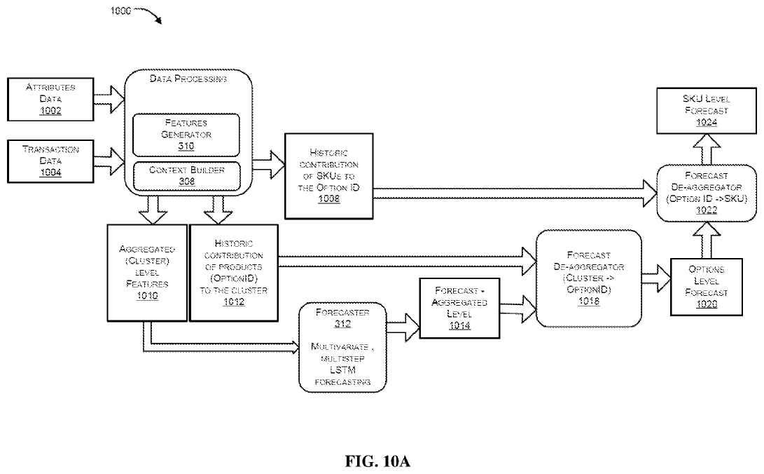

In block (802), the method may include, collecting historical demand data and build features for every product. In step (804), the method may include building causal models by quantifying the relationship between the price and the demand. In step (806), the method may include obtaining causal weights such as self-causal-weights, as shown in FIG. 9E.

As depicted in FIG. 9E, for a given day and a discount percentage of the product, the demand is forecasted. Since the price and the date are the environmental feature, the XGBoost model forecasts the causal parameter. The causal parameter is multiplied with the demand to estimate a correction of the demand. For example, for Product 1, weekend sales and weekday sales differ despite having the same discount percentage. FIG. 8C illustrates an exemplary flow chart depicting cross-causality (807), in accordance with an embodiment of the present disclosure.

In an embodiment, the cross-causality may include quantifying the effect of the price variability for one product on competitors. The cross-causality may include determining the change in the price of the product that affects the demand of competitors. Further, the cross-causality may work on competitor clusters that replicate similar attributes of the products.

The Change in discount/price=Cause

Change in demand for competitor products=Effect

Updated Quantity=\hat{D}= [symbol] *ƒ_{P→CR}(pₖ) Equation 12

Training the model may be based on equations below:

CR=ƒ_{P→CR}(P)=ƒ_{(Price,Date,CompetitorPrice)} Equation 13

CompetitorPriceFeatures=discount % oncompetitor Equation 14

Inference may be for instance, for a given date, a change in the price due to a change in the discount, infer based on equation 15 below:

CR=ƒ_{P→CR}(P)=ƒ_{(Price,Date,CompetitorPrice)} Equation 15

wherein the PDP may be forecasted using the forecast model to get updated quantity “\hat{D}” and updated revenue “\hat{R}”.

The cross-causality may be an approach to calculating the causal parameter to quantify the effect of the price variability of the product on its competitors. The causal parameter i.e., the Conversion Rate (CR) may be the function of the price and the environmental features. Hence, “X” value may consist of a discount for a product offered as a price feature and competitor products discount, and different levels of date features such as day, month, year, week representations, and quarter representations. Further, the target value “Y” may be the Conversion Rate (CR). Thereafter, estimating the function ƒ_{P→CR} such that, CR=ƒ_{P→CR}(P)=ƒ_{(P}_{_{self}}_{,P}_{_{Competitors}}₎. “Pself” may refer to the price feature of self and “PCompetitors” may refer to the price features of the competitors. The Conversion Rate

$$( C R ) = \frac{D}{P D P} , ,$$

wherein “D” may refer to the actual sold quantity/demand.

At block 802, the method may include, for every competition cluster, collecting a historical demand data of all products in the cluster and build features.

At block 812, the method may include, building the causal model by quantifying the relationship between the demand for a product and the price of competing products.

At block 814, the method may include, obtaining the causal model parameters and weights such as cross causal weights as depicted in FIG. 9F.

As depicted in FIG. 9F, for a given day and discount features for the self products and the competitor products belonging to a same cluster, the demand may be forecasted. In an embodiment, the XGBoost model may take the date, the self-price, and the competitor price features as an input, use derived latent features for the product on the cluster level to achieve the causal parameter. The causal parameter is further multiplied with the demand to achieve a demand correction. The price features for the self products and the competitor products are given in the figure. The right-side of the table block may help to visualize the demand variability of the self products and the competitor products.

FIG. 9A and 9B illustrate exemplary flow diagram representations of training a product level self-causal model without competitor weights (900) and with competitor weight (901), respectively, in accordance with an embodiment of the present disclosure.

In step (902), the self-causal model such as the XG boost model (906) may take a pre-processed data (902), such as the article data (410), the transaction data (412), and the visibility data (414). In step (904) the self-causal model such as the XG boost model (906) may perform an engineering of the features. The features may include, but not limited to, causal features, target features, and the like. The casual features may include, but not limited to, a discount percentage, a year, a month, a day, a day of a week, a day of the year, a weekday, a week number, a quarter number, days in the month, a start of the month, an end of the month, a quarter start, a quarter end, an end of the year, a start of the year, a back2school, a back2school prior, a back2school posterior, a leap year, and the like. Further, the target feature may include, but not limited to, the conversion rate, and the like. In step (908), the self-causal model such as the XG boost model (906) may provide a trained product level self-causal model (908).

Referring to FIG. 9B, in step (902), the self-causal model such as the XG boost model (906) may take the pre-processed data (902), such as the article data (410), the transaction data (412), and the visibility data (414). In step (904) the self-causal model such as the XG boost model (906) may perform the engineering of the features. At step (910), the self-causal model such as the XG boost model (906), the engineering of the features may receive competitive clusters. In step (908), the self-causal model such as the XG boost model (906) may provide the trained product level self-causal model.

FIG. 9C and 9D illustrate exemplary flow diagram representations (909, 911) of the Conversion Rate (CR) inference using the trained product level self-causal model without competitor weights and with competitor weights, in accordance with an embodiment of the present disclosure.

Referring to FIG. 9C, in step (912), the self-causal model such as the XG boost model (906) may be inferred (918), which may take a product and price information as input (912).

In step (914) the self-causal model such as the XG boost model (906) may be inferred (918) by performing the engineering of the features. In step (916), the self-causal model such as the XG boost model (906) may receive weights of the product level causal model to the engineering of the features. In step (920), the self-causal model such as the XG boost model (906) may be inferred (918) to provide a predicted causal parameter CR=f_{p→CR} (P), where “P’ may refer to the price feature.

Referring to FIG. 9D, in step (912), the self-causal model such as the XG boost model (906) is inferred (918), which may take the product and price information as the input.

In step (914) the self-causal model such as the XG boost model (906) may be inferred (918) by performing the engineering of the features. At step (910), the self-causal model such as the XG boost model (906) may receive the competitive clusters to the engineering of the features. In step (916), the self-causal model such as the XG boost model (906) may receive the weights of the product level causal model to the engineering of the features. In step (920), the self-causal model such as the XG boost model (906) may be inferred (918) to provide the predicted causal parameter CR=f_{p→CR}(P), where “P’ may refer to the price feature.

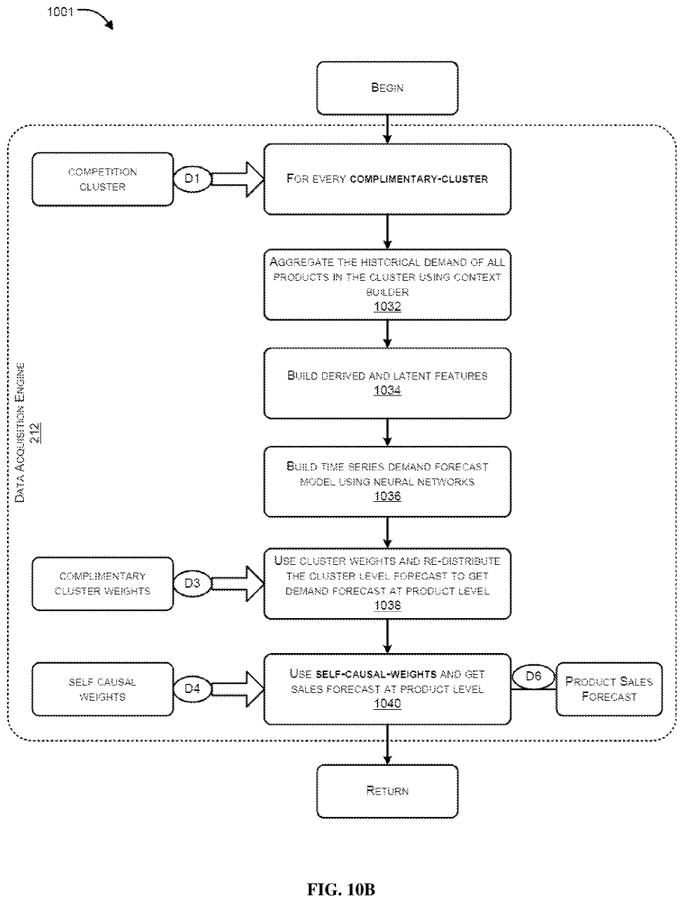

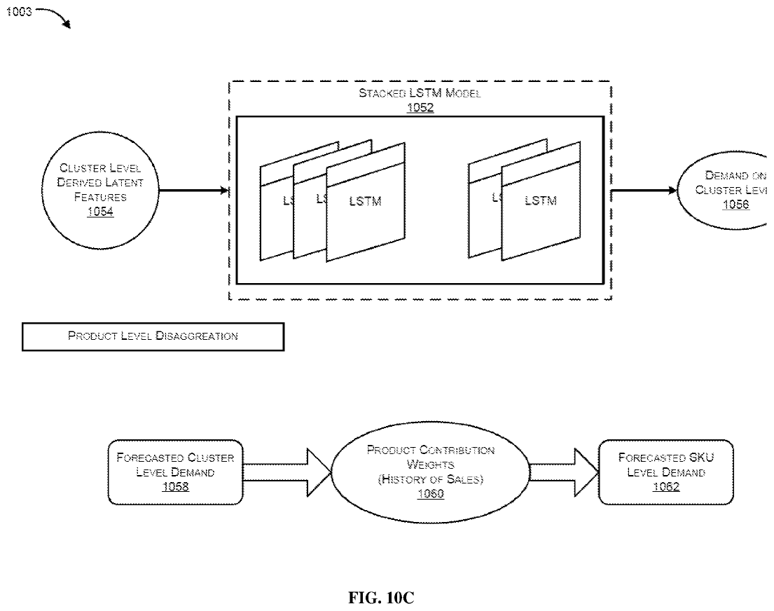

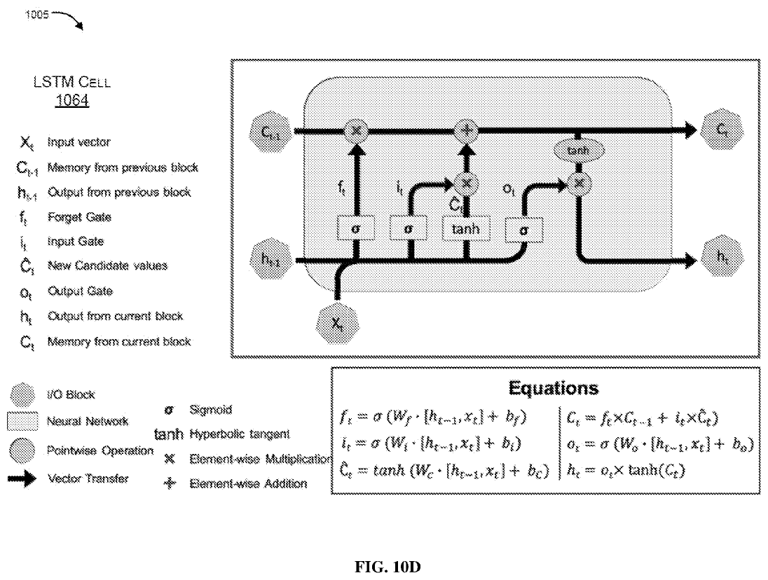

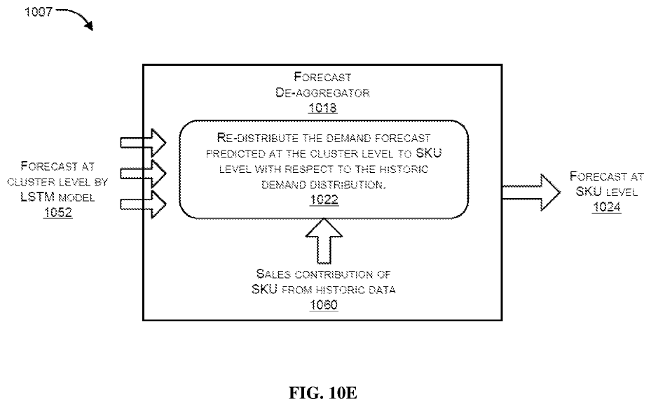

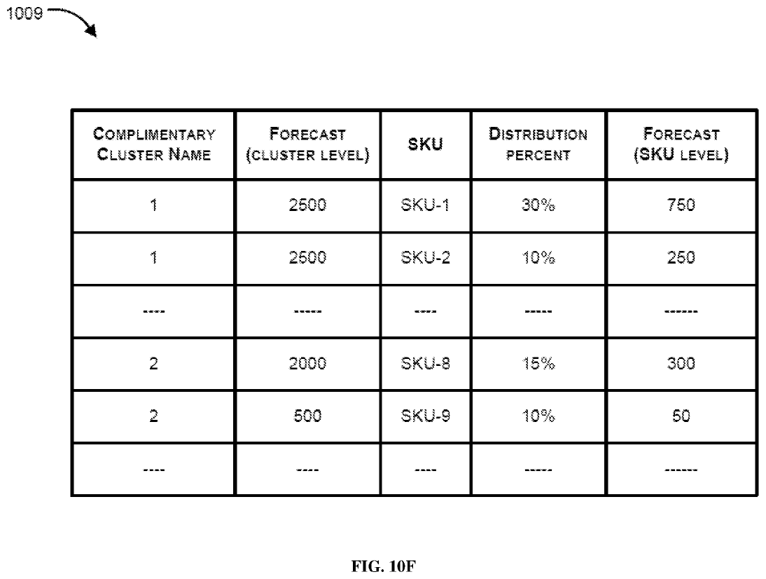

FIG. 10A illustrates an exemplary flow diagram representation of hierarchical forecasting flow (1000), in accordance with an embodiment of the present disclosure.

An attributes data (1002) and a transaction data (1004) may be provided as input to the features generator (310) and the context builder (308) for data processing. Further, the features generator (310) and the context builder (308) may output a historic contribution of SKUs to an option ID (1008), an aggregated (cluster) level features (1010), and a historic contribution of products (option ID) to the cluster (1012). Further, the historic contribution of SKUs to the option ID (1008) may be provided to the forecast de-aggregator (option ID->SKU) (1022). The aggregated (cluster) level features (1010) may be provided to the forecaster (312), which may include a multivariate, multistep LSTM forecasting, and output a forecast aggregated level (1014). The forecast aggregated level (1014) and the historic contribution of products (option ID) to the cluster (1012) may be fed to the forecast de-aggregator (cluster->option ID) (1018). The forecast de-aggregator (cluster->option ID) (1018) may output options level forecast (1020), which is then fed to the forecast de-aggregator (option ID->SKU) (1022). The output of the forecast de-aggregator (option ID->SKU) (1022) is a SKU level forecast (1024).

FIG. 10B illustrates an exemplary flow chart (1001) depicting demand forecasting, in accordance with an embodiment of the present disclosure.

In step (1032), for every competition and complementary cluster, the method may include aggregating the historical demand of all products in the cluster using the context builder (308). In step (1034), the method may include building derived features and latent features. In step (1036), the method may include building a time series demand forecast model using neural networks. In step (1038), the method may include using cluster weights and re-distributing a cluster level forecast to get a demand forecast at a product level, by using complementary cluster weights. In step (1040), the method may include using self-causal weight and receiving sales forecast at the product level, using self-causal weights and a product sales forecast.

To receive the forecast such as a demand and sales forecast at the product level, a stacked LSTM model (1052) may be used as shown in FIG. 10C. The input to the stacked LSTM model (1052) may be the forecasted cluster level demand (1058), and the output may be forecasted SKU level demand (1062). The stacked LSTM model (1052) may be a type of recurrent neural network which learns order dependencies between items in a sequence. Due to its dependency learning, the stacked LSTM model (1052) may be suitable for learning a context required to predict a time series forecasting.

The stacked LSTM model (1052) may have an LSTM cell (1064), as shown in FIG. 10D, with a cell state and three gates which provides them with the power to selectively learn, unlearn or retain information from each of the units. The cell state in the LSTM cell (1064) may help with an information flow through a unit without being altered by allowing only a few linear interactions. The unit in the LSTM cell (1064) may have an input gate, an output gate, and a forget gate which may add or remove the information to the cell state. The forget gate decides which information from the previous cell state should be forgotten for which it uses a sigmoid function. The input gate controls the information flow to a current cell state using a point-wise multiplication operation of ‘sigmoid’ and ‘tank’ respectively. Finally, the output gate decides which information should be passed on to a next hidden state.

Features for the LSTM cell (1064) may be the pre-processed data which is an aggregated demand/sales on the cluster level. After the aggregation, the LSTM cell (1064) may derive the latent features as an input to an LSTM network. Hence, a forecast may be on an aggregated cluster level and disaggregated demand on the sales contribution basis for product level. Derived latent features in cluster may include, but not limited to, lag features, brand popularity, neckline type popularity, sleeve type popularity, product importance within a cluster, average demand/sales quantity per product in the cluster.

Here the derived latent features may be fed as “X” features to the LSTM cell (1064) via the LSTM model (1052) to forecast the quantity as “Y” features.

X−f_((Date, Derived Latent Features→Demand)) Equation 16

Y−Demand Equation 17

Training:

X−f_((Date, Derived Latent Features→Demand)) (i.e., Equation 16)

Y−Demand (i.e., Equation 17)

Inference: For an updated discount, using the derived latent features from the history and environmental variables such as date and time as features, we predict the Demand.

Y=f_((Date, Derived Latent Features→Demand)) Equation 18

FIG. 10E illustrates an exemplary block diagram representation of the forecast de-aggregator (1064), in accordance with an embodiment of the present disclosure.

The forecast de-aggregator (1018) may receive an input of a demand forecast at a cluster level by the LSTM model (1052). The forecast de-aggregator (1018) may re-distribute the demand forecast predicted at the cluster level to the SKU level with respect to the historic demand distribution (1022) by receiving input as sales contribution of SKU from a historic data (1060), and the output forecast at SKU level (1024).

The forecast at SKU level may be according to equation 19:

forecast (SKU level)=Forecast (cluster level)*Distribution percent Equation 19

In the above equation 19,

the distribution percent=historic_data Equation 20

Group by (SKU)[Demand].sum( )/historic_data[Demand].sum( )100 Equation 21

The exemplary results of calculations using above equations may be represented (1065) as shown in table of FIG. 10F.

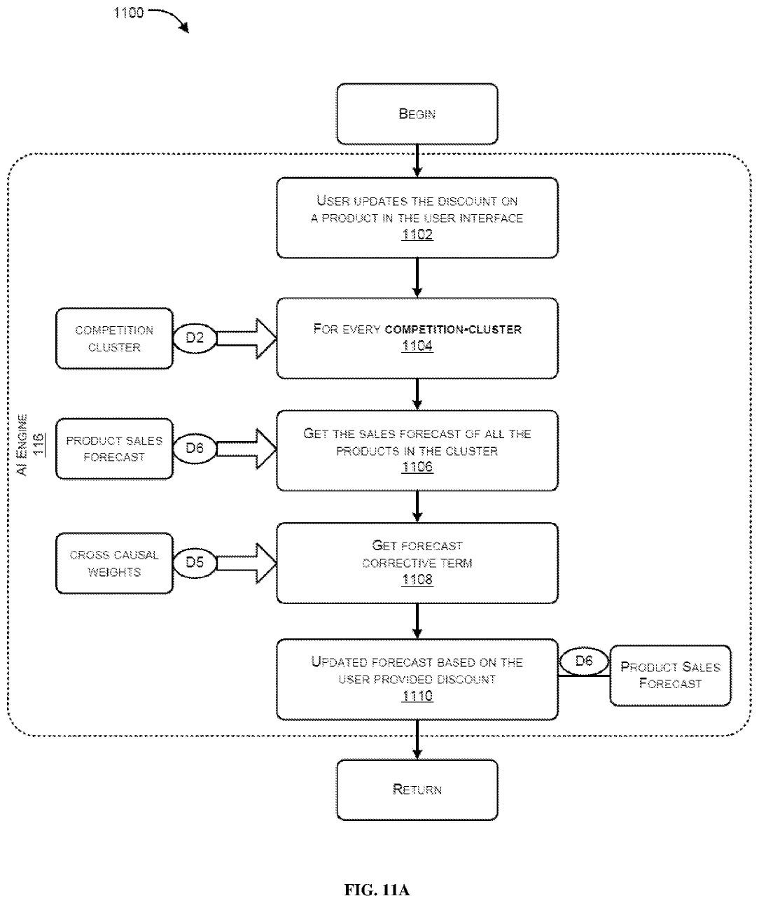

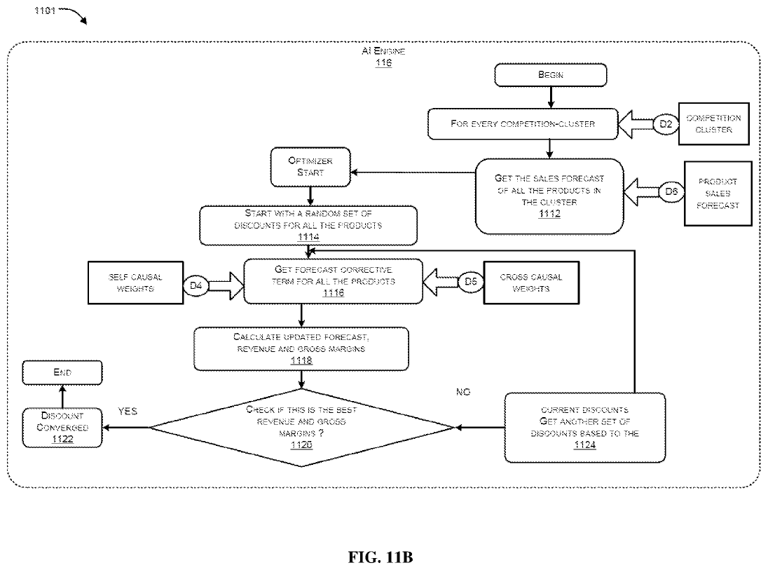

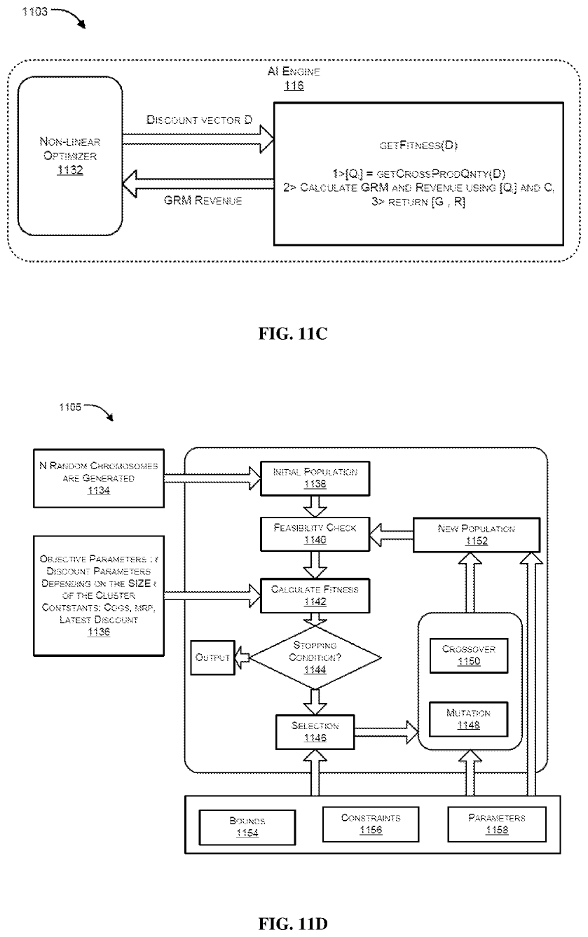

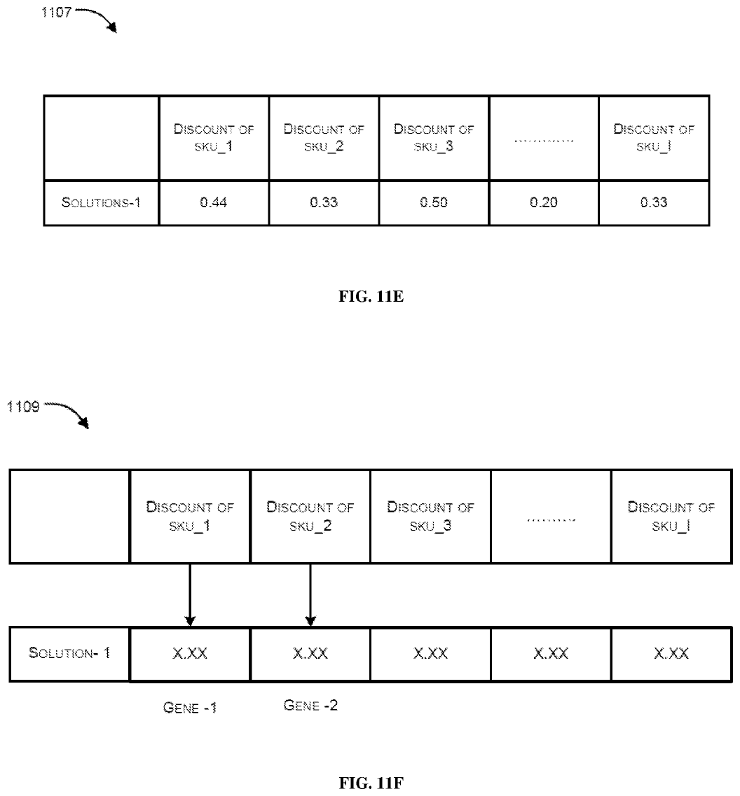

FIG. 11A illustrates an exemplary flow chart depicting discount simulation flow (1100), in accordance with an embodiment of the present disclosure.

A discount simulation module of the system (110) may provide an experimentation platform for the user (102) to understand an effect of a custom discount on global parameters such as the revenue and the gross margin price.

At step (1102), the method may include updating via the entity (114), the discount on the product in a user interface.

For a competition cluster (1104), in step (1106), the method may include receiving the sales forecast of the products in the competition cluster.

In step (1108), the method may include receiving a forecast corrective term.

In step (1110), the method may update the forecast based on the entity (114) provided discount.

FIG. 11B illustrates an exemplary flow chart depicting a discount optimization flow (1111), in accordance with an embodiment of the present disclosure.

The discount optimization flow may be as follows, such as assuming a product cluster “C”, which may have “I” number of products. Let “Dᵢ” be the discount on product “i” in the cluster. The discount vector may be given by D. An objective function, maximizing a total revenue: i.e.,maximize(R), may be based on equation 22 below:

R=Σᵢ₌₁^{I}(1−Dᵢ)*Pᵢ*Qᵢ Equation 22

In equation 22, “Pᵢ” may refer to the MRP of product “i” and, “Qᵢ” may be the expected sales of the product “i” at the discount “Dᵢ”.

Constraints may be to meet a minimum threshold for the gross margin (GRM): i.e., GRM≥GRMₜₕ, may be based on equation 23 below:

GRM=Σᵢ₌₁^{I}{[(1−Dᵢ)*Pᵢ]−Cᵢ}/[(1−Dᵢ)*Pᵢ] Equation 23

In equation 23, “Cᵢ” may refer to a cost of product “i” , and, “GRMₜₕ” may refer to a user input.

In an embodiment, the discount may have an upper bound and a lower bound of 0.2 and 0.8. Qᵢ may refer to a non-linear function that depends on D. Qᵢ=ƒ(D). The term ƒ(D) may be the cross-effects causality model.

An optimization fitness call may be obtained using a non-linear optimizer 1132 as shown in FIG. 11C (1125).

Referring to FIG. 11B, at step (1112), the method may include, for the competition cluster, receiving a sales forecast of the products in the cluster using the product sales forecast.

In step (1114), the method may include, based on a starting optimizer, starting with a random set of discounts for the products. In step (1116), the method may include receiving the forecast corrective term for the products using a self-causal weight and a cross-causal weight. In step (1118), the method may include calculating an updated forecast, the revenue, and the gross margin. In step (1120), the method may include checking if the calculated revenue gross margin corresponds to the best revenue and the gross margin. If yes, then in step (1122), the method may include providing a converged discount. If no, then in step (1124), the method may include receiving another set of discounts based on a current discount.

FIG. 11D illustrates an exemplary block diagram representation (1126) of Genetic Algorithm (GA) optimizer flow, in accordance with an embodiment of the present disclosure.

Using the genetic algorithm, an optimization problem may be modelled into a non-linear constrained problem. Conventionally there may be no known method to find a global maximum/minimum for these problems. Conventional optimization techniques may rely on derivates to find a local optimal solution that are in general local in scope and not very robust towards noise. The genetic algorithm may be a meta-heuristic global method that relies on the principles of Darwinian natural selection and may come under the broad category of evolutionary algorithms. Britannica states natural selection as the “process that results in the adaptation of an organism to its environment through selectively reproducing changes in its genotype”(can be loosely translated as the very famous “survival of the fittest”). Very similarly, the genetic algorithm may start with a random set of a population (i.e., a feasible solution space). A generation good solution may be favored over the bad one and may be passed on to the next generation, where they may be mutated and cross overed to produce an offspring population. This process is continued until a termination condition is met. The “good”, or “bad” solution may be decided by the environment, therein this case the objective function.

In an instance, M (number of generation), N (size of the population), k (population size for tournament selection), p_c (probability of cross over), p_m (probability of mutation), and l (length of the chromosome) may be fixed.

In step (1134), the method may include generating an “N” number of random chromosomes. In step (1136), the method may include providing objective parameters: [symbol] , discount parameters depending on the size [symbol] of the cluster, in which constants may be COGS (Cost of Goods), MRP, and latest discount. In step (1138), the method may include creating an initial population of real coded “N” chromosomes. A chromosome of length l (is the number of SKUs in the cluster) may be created randomly from a search space that satisfies the boundary conditions.

In step (1140), the method may include checking a feasibility. The feasibility of the population is checked with respect to the constraints. If some chromosomes are not satisfied then they may be repaired. In step (1142), the method may include calculating a fitness. The fitness (objective function) of the chromosomes in the population is calculated. The fitness decides the goodness of the chromosomes. Higher the fitness value higher the chances of selection. In step (1144), the method may include checking of a stopping condition to provide the output. In step 1146, the method may include selection of bounds (1154), constraints (1156), and parameters (1158). Two parent chromosomes may be selected. For a selection tournament, a selection method may be used. Further, in step (1148), the method may include a mutation of an offspring chromosome with a probability of p_m followed by an analysis of the feasibility of the mutated offspring chromosomes with respect to the constraints. The method steps 5-9 may be repeated N/2 times until the children population becomes same as the initial population size N.

In step (1150), the method may include crossing over the parent genes with probability p_ to generate a set of two off-springs. Further, the method includes an analysis of the feasibility of the offspring chromosome with respect to the constraints. In step 1152, the method may include replacing the initial population with the newly generated offspring population. This will increase a generation count by one. The method steps 2-10 may be iterated until the generation count becomes M. The chromosomes with the best fitness value from the last generation may be chosen as the optimal solution.

FIG. 11E illustrates an exemplary table of a sample chromosome/solution (1159), in accordance with an embodiment of the present disclosure.

For the chromosomes and genes, a chromosome of length “l” may represent a feasible solution for the optimization problem. In a cluster there may be “l” SKUs. A set of optimal discounts of these SKUs may need to be found for which revenue (the objective function) may be maximized, as shown in table (1159) of FIG. 11E.

FIG. 11F illustrates an exemplary table of illustration of genes in the chromosome (1160), in accordance with an embodiment of the present disclosure.

An “i-th” gene in the chromosome represents a discount for the i-th SKU in the cluster as shown in table of FIG. 11F. Since discount variables may be real valued parameters, real coding may be used instead of the binary coding to define the chromosomes.

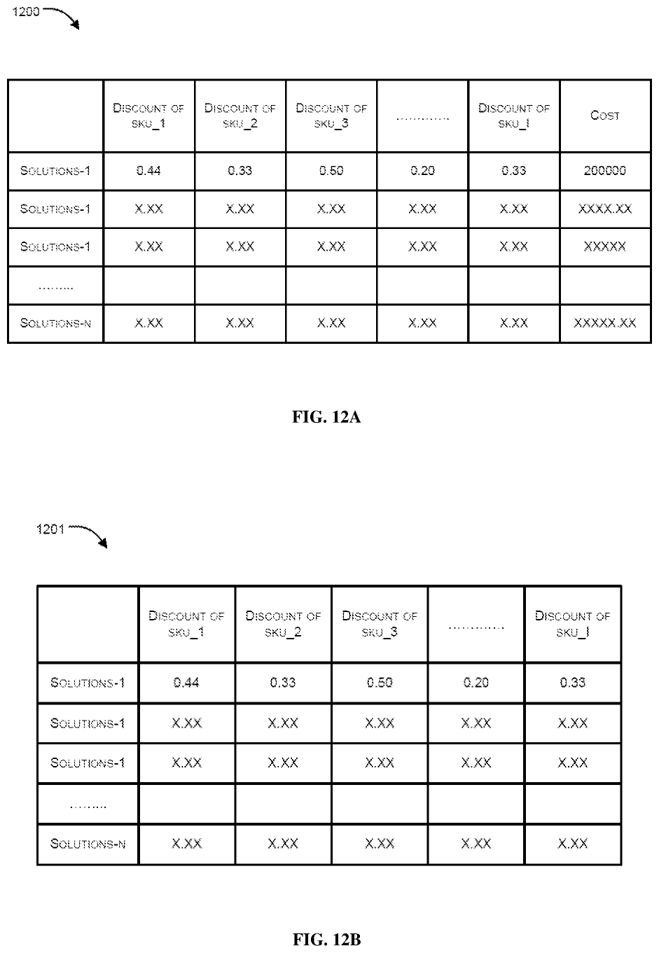

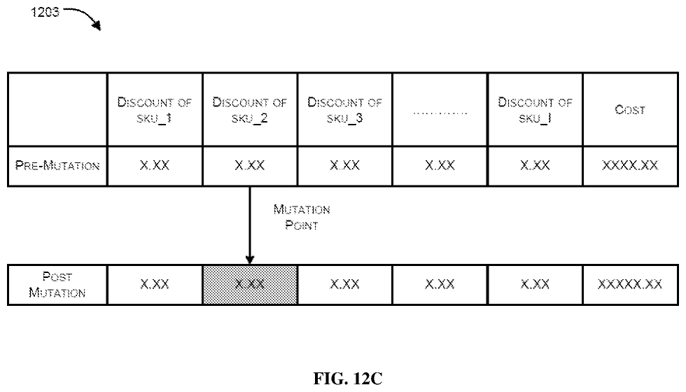

FIG. 12A illustrates an exemplary table of N-chromosomes/solution (1200), in accordance with an embodiment of the present disclosure.

The genetic algorithm may begin with an initial population of real coded “N” chromosomes. A chromosome of length “l” (number of SKUs in the cluster) may be created randomly from the search space which satisfies the boundary conditions. For instance, an i-th position value of the chromosome may be created by L_i+(U_i-L_i)*rand, where L_i and U_i are the lower and upper bound of the discount variable for the i-th sku in the cluster as shown in table of FIG. 12A. The rand may be any random number between [0,1].

Then the feasibility may be checked. The feasibility of the population is checked with respect to the constraints. These constraints are created as per business requirement. For instance, in the problem here, the business wanted a lower bound for the gross margin. The gross margin price may be calculated by subtracting the COGS (cost of goods) from the revenue and then dividing the difference by total revenue, as in equation 24 below:

$$Gross margin ( G M ) = \frac{Revenue - COGS}{Rvenue} \qquad Equation 24$$

In the above equation, “COGS” may refer to the cost of goods. Another constraint may be that the optimal discount should be within a ten percent limit of the latest discount of the SKU.

Further, the fitness may be checked. The fitness measures the goodness of solutions in the population. A fitness function is an objective function that is to be maximized/minimized. For instance, here in this instance, the fitness function is the total revenue that is to be maximized. The total revenue may depend on the COGS, the MRP, and the discount value. For a given SKU the COGS value and the MRP value are constant. So, the total revenue may be a function of the discount as shown in the table of FIG. 12B (1201).

Further, the selection method may be used to select a parent chromosome from the population to do the cross-over and the mutation to create children chromosomes. There may be several techniques for the selection. The commonly used techniques may be a roulette wheel selection, a tournament selection, a rank selection, a steady state selection, a stochastic universal sampling, etc. Here a combination of tournament selections has been used. In the combination of tournament selections, “k” chromosomes are chosen at random from the population. The fitness measure is calculated for the “k” chromosomes. A chromosome with a highest fitness measure is selected as a first parent to resolve a revenue maximization problem. The process may be repeated again to create a second parent. The first parent and the second parent may be used for the crossover.

Further, the cross-over may be the technique for generating offsprings from the parent chromosomes and it consists of exchanging parts of the parent chromosomes. Hence, from the two parent chromosomes we will get two child chromosomes. There are various cross-over techniques for real-coded genetic algorithms. The most common ones are linear cross-over, blend cross-over, and binary simulated crossover. For instance, here in this instance the blend cross-over for the same with a probability p_c may be considered. In the blend cross-over, for a given parents x and y, where x_i<y_i and where x_i and y_i are the ith parameter values, the blend cross-over randomly selects a child with the ith parameter in the range [x_i−α(y_i−x_i), y_i+α(y_i−x_i)]. It is often suggested that a good choice of α is 0.5

Thereafter, a mutation may be used to alter the genes in the chromosome. When parents with the highest fitness value create a population of off-springs, there may be a high chance that the offsprings may be very similar to the parents. Then the genetic algorithm may be converging locally as shown in the table of FIG. 12C (1202). Mutation may be used in order to bring variations to the offspring population. Randomly created noise values to the parameter genes with a probability p_m, may be added.

Finally, a termination may be triggered when the generation size “M” may be reached.

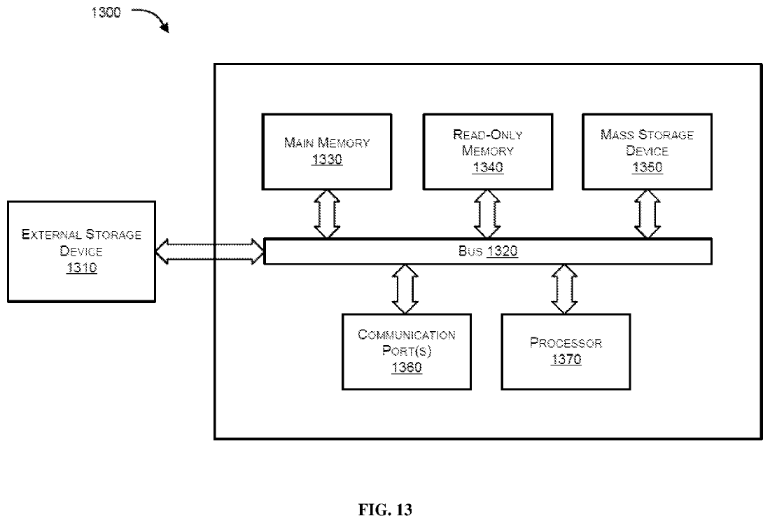

FIG. 13 illustrates an exemplary hardware representation diagram (1300) in which or with which embodiments of the system (110) can be utilized in accordance with embodiments of the present disclosure. As shown in FIG. 13, the computer system (1302) can include an external storage device (1310), a bus (1320), a main memory (1330), a read-only memory (1340), a mass storage device (1350), a communication port (1360), and a processor (1370). A person skilled in the art will appreciate that the computer system may include more than one processor and communication ports. Examples of processor (1370) may include, but are not limited to, an Intel® Itanium® or Itanium 2 processor(s), or AMD® Opteron® or Athlon MP® processor(s), Motorola® lines of processors, FortiSOC™ system on chip processors or other future processors. The processor (1330) may include various modules associated with embodiments of the present disclosure. The communication port (1360) can be any of RS-232 port for use with a modem-based dialup connection, a 10/100 Ethernet port, a Gigabit, or 10 Gigabit port using copper or fiber, a serial port, a parallel port, or other existing or future ports. The communication port (1360) may be chosen depending on a network, such as a Local Area Network (LAN), a Wide Area Network (WAN), or any network to which the computer system (1302) connects. The memory (1330) can be Random Access Memory (RAM), or any other dynamic storage device commonly known in the art. The Read-only memory (1340) can be any static storage device(s) e.g., but not limited to, a Programmable Read Only Memory (PROM) chip for storing static information e.g., start-up or BIOS instructions for the processor (1370). The mass storage (1350) may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), e.g. those available from Seagate (e.g., the Seagate Barracuda 782 family) or Hitachi (e.g., the Hitachi Deskstar 13K800), one or more optical discs, Redundant Array of Independent Disks (RAID) storage, e.g. an array of disks (e.g., SATA arrays), available from various vendors including Dot Hill Systems Corp., LaCie, Nexsan Technologies, Inc. and Enhance Technology, Inc.

The bus (1320) communicatively couples the processor(s) (1370) with the other memory, storage, and communication blocks. The bus (1320) can be, e.g., a Peripheral Component Interconnect (PCI)/PCI Extended (PCI-X) bus, Small Computer System Interface (SCSI), USB, or the like, for connecting expansion cards, drives, and other subsystems as well as other buses, such a front side bus (FSB), which connects the processor (1370) to the system (1302).

Optionally, operator and administrative interfaces, e.g., a display, keyboard, and a cursor control device, may also be coupled to the bus (1320) to support direct operator interaction with a computer system. Other operator and administrative interfaces can be provided through network connections connected through communication port 1360. The external storage device (1310) can be any kind of external hard drives, floppy drives, IOMEGA® Zip Drives, Compact Disc-Read Only Memory (CD-ROM), Compact Disc-Re-Writable (CD-RW), Digital Video Disk-Read Only Memory (DVD-ROM). Components described above are meant only to exemplify various possibilities. In no way should the aforementioned exemplary computer system limit the scope of the present disclosure. While considerable emphasis has been placed herein on the preferred embodiments, it will be appreciated that many embodiments can be made and that many changes can be made in the preferred embodiments without departing from the principles of the invention. These and other changes in the preferred embodiments of the invention will be apparent to those skilled in the art from the disclosure herein, whereby it is to be distinctly understood that the foregoing descriptive matter is to be implemented merely as illustrative of the invention and not as a limitation.

### ADVANTAGES OF THE PRESENT DISCLOSURE

The present disclosure provides for a method and system for forecasting a demand for a product based on a price of the product for profit optimization in an online/offline retail/wholesale category.

The present disclosure provides a robust and effective solution to the online/offline retail/wholesale category for forecasting a demand, recommending an optimal price, and providing a simulation environment for discount effects of products in the online/offline retail/wholesale category. The recommended optimal price of the products in the online/offline retail/wholesale environment is not localized, but global in nature.

The present disclosure provides for a method and system for segmenting products into complementary and competitive clusters on the basis if product attributes in order to facilitate discount recommendation and price optimization of products on the basis of product attributes.

The present disclosure involves a product segmentation module, a demand forecasting module, a causality module, and a non-linear optimizer module. Demand forecasting may be performed using a stacked Long- and Short-Term Memory (LSTM) neural network architecture. The non-linear optimization may be performed using the real-valued Genetic Algorithms (GA). The causal models use the eXtreme Gradient Boosting (XGBoost) to quantify the inter-product effects. At every stage of modelling local features such as calendar events and demographic parameters may be used, which helps in the quantification of the price-demand causal effects and the inter-product/cross causal effects.

### RESERVATION OF RIGHTS

A portion of the disclosure of this patent document contains material, which is subject to intellectual property rights such as but are not limited to, copyright, design, trademark, IC layout design, and/or trade dress protection, belonging to Jio Platforms Limited (JPL) or its affiliates (herein after referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner. The present disclosure may pertain to 3GPP specifications such as for example 3GPP TS 29.198-04-5, version 9.0.0, Release 9.

We claim:

1. A system for price optimization (110), the system comprising:
a processor (202);
a memory (204) coupled to the processor (202), wherein the memory (204) comprises processor-executable instructions, which on execution, causes the processor (202) to:
segment one or more products into a complementary product cluster or a competitive product cluster based on a demand history data of the one or more products and attributes of the one or more products;
perform a demand forecast of the one or more products in the product cluster based on the demand history data of the one or more products and attributes of the one or more products;
perform a causality analysis of the one or more products in the product cluster based on the demand forecast of the one or more products in the product cluster; and
set an optimal price of the one or more products based on the causality analysis of the one or more products by a non-linear price optimization technique.

2. The system as claimed in claim 1, wherein the demand history data of the one or more products is stored in a database (210).

3. The system as claimed in claim 1, wherein the segmentation of the one or more products into a complementary product cluster or a competitive product cluster is performed by a K-Nearest Neighbour (KNN) clustering technique.

4. The system as claimed in claim 1, wherein the one or more products are segmented into the competitive product cluster if product attributes are similar.

5. The system as claimed in claim 1, wherein the one or more products are segmented into the complementary product cluster if product attributes are dissimilar.

6. The system as claimed in claim 1, wherein the demand forecast of the one or more products in the product cluster is performed by using a stacked Long- and Short-Term Memory (LSTM) neural network architecture and comprises a demand sensing for the one or more products to consider a long-term demand for the one or more products and a short-term demand for the one or more products.

7. The system as claimed in claim 1, wherein the demand forecast of the one or more products in the product cluster yields a demand forecast for a plurality of Stock Keeping Units (SKUs) of the one or more products.

8. The system as claimed in claim 1, wherein the causality analysis of the one or more products in the product cluster based on the demand forecast of the one or more products in the product cluster is performed by using an eXtreme Gradient Boosting (XGBoost) technique and comprises a quantification of inter-product effects of the one or more products in the product cluster to predict a conversion rate of the conversion of the demand for the one or more products into a sale of the one or more products.

9. The system as claimed in claim 1, wherein the optimal price of the one or more products set by a non-linear price optimization technique is determined by using a real-valued Genetic Algorithm (GA) to globally maximize a revenue and a margin associated with the one or more products.

10. A method for price optimization, the method comprising:
segmenting, by a processor, one or more products into a complementary product cluster or a competitive product cluster based on a demand history data of the one or more products and attributes of the one or more products;
performing, by the processor, a demand forecast of the one or more products in the product cluster based on the demand history data of the one or more products and attributes of the one or more products;
performing, by the processor, a causality analysis of the one or more products in the product cluster based on the demand forecast of the one or more products in the product cluster; and
setting, by the processor, an optimal price of the one or more products based on the causality analysis of the one or more products by a non-linear price optimization technique.

11. The method as claimed in claim 10, wherein the demand history data of the one or more products is stored in a database (210).

12. The method as claimed in claim 10, wherein the segmentation of the one or more products into a complementary product cluster or a competitive product cluster is performed by a K-Nearest Neighbour (KNN) clustering technique.

13. The method as claimed in claim 10, wherein the one or more products are segmented into the competitive product cluster if product attributes are similar.

14. The method as claimed in claim 10, wherein the one or more products are segmented into the complementary product cluster if product attributes are dissimilar.

15. The method as claimed in claim 10, wherein the demand forecast of the one or more products in the product cluster is performed by using a stacked Long- and Short-Term Memory (LSTM) neural network architecture and comprises a demand sensing for the one or more products to consider a long-term demand for the one or more products and a short-term demand for the one or more products.

16. The method as claimed in claim 10, wherein the demand forecast of the one or more products in the product cluster yields a demand forecast for a plurality of Stock Keeping Units (SKUs) of the one or more products.

17. The method as claimed in claim 10, wherein the causality analysis of the one or more products in the product cluster based on the demand forecast of the one or more products in the product cluster is performed by using an eXtreme Gradient Boosting (XGBoost) technique and comprises a quantification of inter-product effects of the one or more products in the product cluster to predict a conversion rate of the conversion of the demand for the one or more products into a sale of the one or more products.

18. The method as claimed in claim 10, wherein the optimal price of the one or more products set by a non-linear price optimization technique is performed by using a real-valued Genetic Algorithm (GA) to globally maximize a revenue and a margin associated with the one or more products.
